(19) United States
(12) Patent Application Publication
(10) Pub. No.: US 2025/0332512 A1
(43) Pub. Date: Oct. 30, 2025

(54) Virtual Character Posture Editor

(71) Applicant: Tencent Technology (Shenzhen) Company Limited, Shenzhen (CN)

(72) Inventors: Yingting Zhu, Shenzhen (CN); Liang Kang, Shenzhen (CN); Danxing Xu, Shenzhen (CN); Kuntao Zhang, Shenzhen (CN)

(21) Appl. No.: 19/258,485

(22) Filed: Jul. 2, 2025

Related U.S. Application Data
(63) Continuation of application No. PCT/CN2024/097329, filed on Jun. 4, 2024.

(30) Foreign Application Priority Data
Jun. 30, 2023 (CN) 2023108008706

(51) Int. Cl. A63F 13/63; A63F 13/58

(52) U.S. Cl. CPC A63F 13/63; A63F 13/58

(57) ABSTRACT

Virtual character posture editing techniques for use with three-dimensional virtual environments are described herein. The method includes: obtaining at least one candidate group posture, each candidate group posture of the at least one candidate group posture corresponding to postures of at least two virtual characters; displaying, in a virtual environment in response to a selection operation on a first group posture of the at least one candidate group posture, at least two circular regions corresponding to the first group posture, the at least two circular regions being in a one-to-one correspondence with postures of at least two virtual characters in the first group posture; and displaying, after different virtual characters enter different circular regions of the at least two circular regions, postures corresponding to the circular regions in which all the different virtual characters are located. Therefore, a group image adjustment solution for a virtual character posture is provided.

### CROSS-REFERENCE TO RELATED APPLICATIONS

This application is a Continuation Application of PCT Application PCT/CN2024/097329, filed Jun. 4, 2024, which claims priority to Chinese Patent Application No. 2023108008706, filed Jun. 30, 2023, each entitled “VIRTUAL CHARACTER POSTURE EDITING METHOD AND APPARATUS, DEVICE, AND STORAGE MEDIUM” and each of which is incorporated herein by reference in its entirety.

### FIELD

Aspects described herein relate to the field of three-dimensional virtual environments, and in particular, to virtual character posture editing.

### BACKGROUND

In a game supporting three-dimensional virtual environments, a user may operate a virtual character in a three-dimensional virtual environment to perform various activities such as walk, run, attack, and release a skill.

In a related technology, a virtual character is implemented by using a three-dimensional skeleton model. Postures of the virtual character in various activity statuses are presented according to preset skeleton animations. A user may operate the virtual character to move to different positions in a three-dimensional virtual world and present a posture according to a preset skeleton animation for photographing and sharing.

However, in a scenario in which a plurality of users control a plurality of virtual characters for photographing, it is very complicated and time-consuming to implement a complex combined multi-person action according to a preset skeleton animation, and postures that can be photographed and shared are very limited.

### SUMMARY

This application provides a virtual character posture editing method and apparatus, a device, a medium, and a program product. The technical solutions are as follows:

According to one aspect described herein, a virtual character posture editing method is provided. The method is performed by a terminal and includes:
obtaining at least one candidate group posture, each candidate group posture of the at least one candidate group posture corresponding to postures of at least two virtual characters;
displaying, in a virtual environment in response to a selection operation on a first group posture of the at least one candidate group posture, at least two circular regions corresponding to the first group posture, the circular regions being in a one-to-one correspondence with postures in the first group posture; and
displaying, after different virtual characters enter different circular regions of the at least two circular regions, postures corresponding to the circular regions in which the different virtual characters are located.

According to One Aspect Described Herein, a Virtual Character Posture Editing Method is Provided. The Method is Performed by a Client in which a Second Account is Logged into and Includes:
displaying, in a virtual environment, at least two circular regions corresponding to a first group posture, the first group posture corresponding to postures of at least two virtual characters, the first group posture being placed by a first account in the virtual environment, and the circular regions being in a one-to-one correspondence with the postures in the first group posture;
controlling a second virtual character to enter a second circular region of the at least two circular regions, and controlling the second virtual character to apply, in the second circular region, a second posture corresponding to the second circular region;
displaying the second virtual character of the second posture located in the second circular region; and
displaying, after another virtual character enters another circular region of the at least two circular regions, a posture corresponding to the circular region in which the another virtual character is located.

According to one aspect described herein, a virtual character posture editing apparatus is provided. The apparatus includes:
a first display module, configured to obtain at least one candidate group posture, each candidate group posture of the at least one candidate group posture corresponding to postures of at least two virtual characters; and
a selection module, configured to display, in a virtual environment in response to a selection operation on a first group posture of the at least one candidate group posture, at least two circular regions corresponding to the first group posture, the circular regions being in a one-to-one correspondence with postures in the first group posture;
the first display module being further configured to display, after different virtual characters enter different circular regions of the at least two circular regions, postures corresponding to the circular regions in which the different virtual characters are located.

According to one aspect described herein, a virtual character posture editing apparatus is provided. The apparatus includes:
a second display module, configured to display, in a virtual environment, at least two circular regions corresponding to a first group posture, the first group posture corresponding to postures of at least two virtual characters, the first group posture being placed by a first account in the virtual environment, and the circular regions being in a one-to-one correspondence with the postures in the first group posture; and
a second control module, configured to control a second virtual character to enter a second circular region of the at least two circular regions, and control the second virtual character to apply, in the second circular region, a second posture corresponding to the second circular region;
the second display module being further configured to display the second virtual character of the second posture located in the second circular region; and
the second display module being further configured to display, after another virtual character enters another circular region of the at least two circular regions, a posture corresponding to the circular region in which the another virtual character is located.

According to another aspect described herein, a computer device is provided. The computer device includes: a processor and a memory, the memory having a computer program stored therein, and the computer program being loaded and executed by the processor to implement the virtual character posture editing method described above.

According to another aspect described herein, a computer-readable storage medium is provided, having a computer program stored therein, the computer program being loaded and executed by a processor to implement the virtual character posture editing method described above.

According to another aspect described herein, a computer program product is provided, having a computer program stored therein, the computer program being loaded and executed by a processor to implement the virtual character posture editing method described above.

According to another aspect described herein, a chip is provided, including a programmable logic circuit and program instructions, and a computer device having the chip installed thereon being configured to implement the virtual character posture editing method described above.

The technical solutions provided in the aspects described herein produce at least the following beneficial effects:

After different virtual characters enter circular regions corresponding to a candidate group posture, postures corresponding to the circular regions can be quickly displayed, thereby reducing a large number of operations in an editing process of a group posture and reducing a large number of operations in a display process of a group posture. A quick, accurate, and convenient UGC generation, application, and sharing solution for a group posture is implemented.

### BRIEF DESCRIPTION OF THE DRAWINGS

FIG. 1 is a structural block diagram of a computer system according to an aspect described herein;

FIG. 2 is a diagram of an interface of a virtual character posture editing method according to an aspect described herein;

FIG. 3 is a flowchart of a posture editing method according to an aspect described herein;

FIG. 4 is a schematic diagram of circular regions corresponding to a group posture according to an aspect described herein;

FIG. 5 is a flowchart of a posture editing method according to an aspect described herein;

FIG. 6 is a flowchart of a posture editing method according to an aspect described herein;

FIG. 7 is a schematic diagram of a posture editing interface according to an aspect described herein;

FIG. 8 is a flowchart of a method for enabling an editing function for a group posture according to an aspect described herein;

FIG. 9 is a schematic diagram of a first entrance of an editing function for a group posture according to an aspect described herein;

FIG. 10 is a schematic diagram of a second entrance of an editing function for a group posture according to an aspect described herein;

FIG. 11 is a schematic diagram of a working principle of a camera model in a virtual environment according to an aspect described herein;

FIG. 12 is a schematic diagram of a posture editing method according to an aspect described herein;

FIG. 13 is a schematic diagram of a posture editing method according to an aspect described herein;

FIG. 14 is a schematic flowchart of a posture editing method according to an aspect described herein;

FIG. 15 is a schematic diagram of a posture editing method according to an aspect described herein;

FIG. 16 is a schematic diagram of a posture editing method according to an aspect described herein;

FIG. 17 is a schematic diagram of skeletons according to an aspect described herein;

FIG. 18 is a schematic flowchart of a posture editing method according to an aspect described herein;

FIG. 19 is a schematic diagram of a posture editing method according to an aspect described herein;

FIG. 20 is a schematic flowchart of a posture editing method according to an aspect described herein;

FIG. 21 is a schematic diagram of a posture editing method according to an aspect described herein;

FIG. 22 is a schematic diagram of a posture editing method according to an aspect described herein;

FIG. 23 is a schematic flowchart of a posture editing method according to an aspect described herein;

FIG. 24 is a schematic diagram of a posture editing method according to an aspect described herein;

FIG. 25 is a schematic flowchart of a posture editing method according to an aspect described herein;

FIG. 26 is a schematic flowchart of a posture editing method according to an aspect described herein;

FIG. 27 is a schematic diagram of a posture editing method according to an aspect described herein;

FIG. 28 is a schematic flowchart of a posture editing method according to an aspect described herein;

FIG. 29 is a schematic diagram of a posture editing method according to an aspect described herein;

FIG. 30 is a schematic diagram of a sharing procedure of a customized group posture according to an aspect described herein;

FIG. 31 is a schematic diagram of a sharing interface of a customized group posture according to an aspect described herein;

FIG. 32 is a schematic diagram of a sharing interface of a customized group posture according to an aspect described herein;

FIG. 33 is a flowchart of a virtual character posture editing method according to an aspect described herein;

FIG. 34 is a schematic structural diagram of a virtual character posture editing apparatus according to an aspect described herein;

FIG. 35 is a schematic structural diagram of a virtual character posture editing apparatus according to an aspect described herein; and

FIG. 36 is a structural block diagram of a computer device according to an aspect described herein.

### DETAILED DESCRIPTION

To make the objectives, technical solutions, and advantages described herein clearer, the following further describes implementations described herein in detail with reference to the accompanying drawings. Illustrative aspects are described in detail herein, and examples of the illustrative aspects are shown in the accompanying drawings. When the following description involves the accompanying drawings, unless otherwise indicated, the same numerals in different accompanying drawings represent the same or similar elements. The following implementations described in the following illustrative aspects do not represent all implementations that are consistent with this application. Instead, the following implementations are merely examples of the apparatus and method according to some aspects described herein as recited in the appended claims.

The terms used described herein are for the purpose of describing specific aspects only and are not intended to limit this application. The singular forms of “a” and “the” used described herein and the appended claims are intended to include the plural forms as well, unless the context clearly indicates otherwise. The term “and/or” used herein indicates and includes any or all possible combinations of one or more associated listed items.

Although the terms such as “first”, “second”, and “third” may be used described herein to describe various information, the information is not limited to these terms. These terms are merely used to distinguish between information of the same type.

First, related technologies in the aspects described herein are simply described below.

Virtual scene: A virtual scene is a scenario displayed or provided when a client of an application program runs on a terminal. The application program includes, but is not limited to, a game application program, an extended reality (XR) application program, a social application program, an interactive entertainment application program, and the like. The virtual scene may alternatively be a simulated scene of a real world, or a semi-simulated and semi-fictional scene, or a purely fictional scene. The virtual scene may be a two-dimensional virtual scene, may be a 2.5-dimensional virtual scene, or may be a three-dimensional virtual scene, which is not limited in this aspect described herein.

Virtual character: A virtual character may move in a virtual scene. The virtual character may be in a form of person, a form of animal, a form of cartoon, or another form. This is not limited in this aspect described herein. The virtual character may be presented in a three-dimensional form or in a two-dimensional form. The three-dimensional form is used as an example in this aspect described herein, but this is not limited.

Skeleton chain: The virtual character described herein is implemented by using a skeleton model, and one skeleton model includes at least one bone chain. Each bone chain is constructed by one or more rigid bones. A joint is connected between two adjacent bones. Bones may alternatively be referred to herein as a skeleton. A joint has or does not have a movement capability. Some bones may rotate and move around a joint. A posture of a skeleton may be adjusted by adjusting a joint parameter of a joint, thereby adjusting the posture of the skeleton and finally implementing posture adjustment of a virtual character.

Inverse kinematics (IK): Inverse kinematics is a technology for determining a skeleton posture of a virtual character. If a skeleton model of a virtual character is considered as a skeleton chain structure with clear layers, a skeleton part located at a root of the skeleton chain may be referred to as a root skeleton, and a skeleton part located at an end of the skeleton chain may be referred to as an end skeleton. Illustratively, according to the IK technology, when a target position of an end skeleton is known, information such as a position and an angle of each joint on a skeleton chain of the end skeleton is solved, so that the end skeleton of the virtual character can move to the target position, and an entire posture of the skeleton chain can be obtained based on position information of the end skeleton. Certainly, when a position of an intermediate skeleton on the skeleton chain is known, a position of another skeleton on the skeleton chain in a virtual environment may alternatively be solved. This is not limited in this aspect described herein.

Posture: Based on an initial posture preset in a system, a user adjusts a virtual character to generate a customized posture by using a posture editor. Posture data and a posture preview image of the customized posture may be stored as a posture work, to conveniently apply or share the customized posture on virtual characters controlled by different accounts. The posture work may be considered as a UGC work.

Posture catalogue: A user stores, in the same network space or program function, a posture work generated by the user and a collected posture work of another user. The network space or program function is referred to as a posture catalogue.

Convenient editing mode: A skeleton point of a virtual character is dragged, so that other skeletons belonging to the same skeleton chain as the skeleton point are driven to change together, so as to adjust a posture of the virtual character. Because positions of a plurality of skeletons can be changed at the same time through one dragging operation, this mode is referred to as a convenient editing mode.

Expert editing mode: A skeleton point of a virtual character is rotated, so that a skeleton position corresponding to the skeleton point is changed, to finely adjust a posture of the virtual character. Because each skeleton is finely adjusted, the posture of the virtual character can be adjusted more finely, and this mode is referred to as an expert editing mode.

Physiological angle limit of skeleton point: The limit refers to whether rotation of each skeleton point about an x/y/z axis is enabled, and maximum and minimum rotatable angle configurations when each skeleton point is rotated on the x/y/z axis.

Editable degree of freedom limit of skeleton point: The limit refers to a maximum rotatable angle change configuration based on a preset initial posture in a system when each skeleton point rotates about the x/y/z axis, and is configured by a staff member or a user.

Share: A posture work generated by a user is sent to a network group, or shared with a friend account in a social relationship chain in a point-to-point manner. The social relationship chain may be a relationship chain in a game, or may be a relationship chain outside a game.

Record: Posture works generated and shared by others are stored and recorded.

One-click application: By using the one-click application function, a customized posture created by a current user or another user may be quickly applied to a virtual character controlled by the current user.

Body shape: Body shapes of different virtual characters may be classified as follows: an adult male body shape, an adult female body shape, a teenage male body shape, a teenage female body shape, an old person body shape, a child body shape, and the like. For brevity, in this aspect described herein, the adult male body shape, the adult female body shape, and the teenage female body shape are used as an example.

Heads-up display (HUD) control: This control is an image for presenting related information or controls in a game, and is usually displayed on an upper layer of a virtual environment image. The virtual environment image is an image obtained by observing a three-dimensional virtual environment with a camera model. The HUD control is the most effective manner for a game world to interact with players. Elements that can convey information to the players through a visual effect can be referred to as HUD. Common HUD controls include an operation control, a prop bar, a map, a blood volume indicator, and the like. The heads-up display control is also referred to as a head-up display control. Described herein, all or some of editing controls are in the form of HUD control.

A game application program is used as an example. In a virtual scenario of a fight technology game (FTG), an action game (ACT), a multiplayer online battle arena (MOBA) game, a real-time strategy game (RTS), a massive/massively multiplayer online game (MMOG), a shooting game (STG), a first personal shooting game (FPS), a third personal shooting game (TPS), an arcade game, and the like, a posture/action of a virtual character controlled by a user is preset in the game, for example, a walking posture, a running posture, or a posture of releasing a skill. The user cannot actively set the posture of the virtual character.

An aspect described herein provides a user generated content (UGC) function for a posture/action of a virtual character. Described herein, a user can customize a position and an angle of each body part of a virtual character in a game based on a preset basic posture in a system by using a posture editor, to generate a customized posture. In addition, the customized gesture can be stored as a gesture work, to be shared with other users, used and recorded by others, and the like. Through a complete UGC output-sharing-application-recording system, common users can more conveniently obtain UGC created works of celebrity users in a game. In addition, creation desire, sharing desire, and social demand of celebrity users are satisfied, fragmented idle time is filled, and good social experience closed-loop is formed.

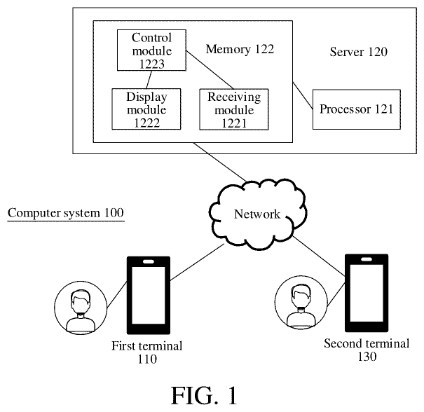

FIG. 1 is a structural block diagram of a computer system according to an illustrative aspect described herein. A computer system 100 includes at least one of a first terminal 110, a server 120, and a second terminal 130.

An application program supporting a virtual environment is installed and run in the first terminal 110, for example, a game application program, an XR application program, a virtual social application program, an interactive entertainment application program, and a metaverse application program. The first terminal 110 is a terminal used by a first user. A posture editor of a virtual character is disposed in the application program, and is configured to generate, share, and record the posture work.

In some aspects, the first terminal 110 can be considered as the first user using the first terminal 110.

The first terminal 110 is connected to the server 120 by using a wireless network or a wired network.

The server 120 includes one of one server, a plurality of servers, a cloud computing platform, and a virtualization center. Illustratively, the server 120 includes a processor 121 and a memory 122. The memory 122 further includes a receiving module 1221, a display module 1222, and a control module 1223. The server 120 is configured to provide a background service for the application program supporting posture editing of a virtual character. In some aspects, the server 120 performs primary computing work, and the first terminal 110 and the second terminal 130 perform secondary computing work. Alternatively, the server 120 performs secondary computing work, and the first terminal 110 and the second terminal 130 perform primary computing work. Alternatively, the server 120, the first terminal 110, and the second terminal 130 perform collaborative computing by using a distributed computing architecture.

An application program supporting a virtual environment is installed and run on the second terminal 130. The second terminal 130 is a terminal used by a second user. A posture editor of a virtual character is disposed in the application program.

In some aspects, the second terminal 130 can be considered as the second user using the second terminal 130.

In some aspects, the first user and the second user are or are not in the same field of view. Alternatively, the first user and the second user are or are not in the same battle. Alternatively, the first user and the second user are or are not in the same battlefield. In some aspects, the first user and the second user may belong to the same team or the same organization, have a friend relationship, or have temporary communication permission.

In some aspects, the application programs installed on the first terminal 110 is same as the application program installed on the second terminal 130, or the application programs installed on the two terminals are the same type of application programs on different control system platforms. The first terminal 110 may generally be one of a plurality of terminals, and the second terminal 130 may generally be one of a plurality of terminals. In this aspect, only the first terminal 110 and the second terminal 130 are used as an example. The first terminal 110 and the second terminal 130 are of the same device type or different device types. The device type includes but is not limited to: at least one of a smartphone, a tablet computer, an e-book reader, a laptop portable computer, a desktop computer, a television, an augmented reality (AR) terminal, a virtual reality (VR) terminal, a mediated reality (MR) terminal, an XR terminal, a baffle reality (BR) terminal, a cinematic reality (CR) terminal, and a deceive reality (DR) terminal. In the following aspects, for example, the terminal includes a smartphone.

A person skilled in the art can know that a number of terminals or users may be more or less. For example, there may be only one terminal or user, or there may be dozens, hundreds, or more terminals or users. A number of terminals or users and a device type are not limited in aspects described herein.

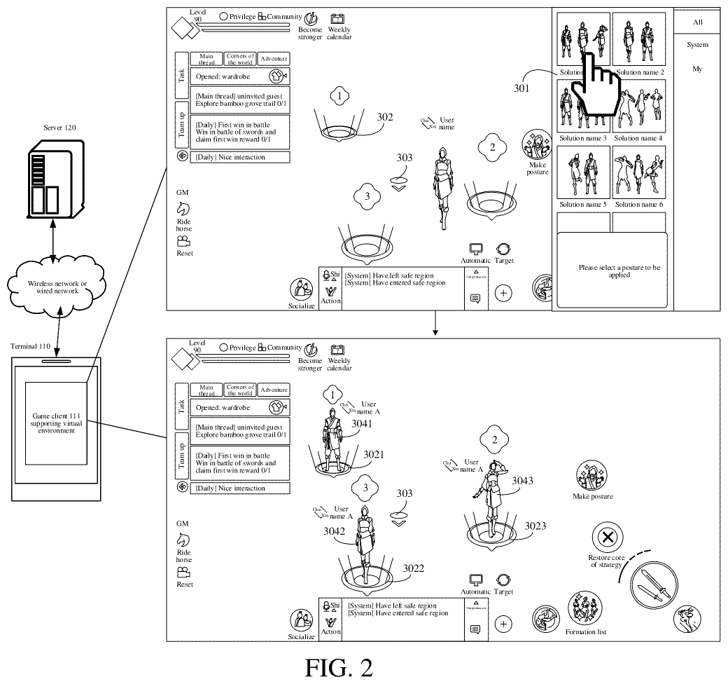

FIG. 2 is a schematic diagram of an interface of a virtual character posture editing method according to an aspect described herein. A game client 111 supporting a virtual environment is installed and run on the first terminal 110. A group posture editor for a virtual character is provided in the game client 111.

In a virtual environment, at least one candidate group posture 301 is obtained, where each candidate group posture of the at least one candidate group posture 301 corresponds to postures of at least two virtual characters.

After a user selects a first candidate group posture from the at least one candidate group posture 301, at least two circular regions 302 corresponding to the first candidate group posture are displayed in a virtual environment, and the at least two circular regions 302 are in a one-to-one correspondence with postures of at least two virtual characters corresponding to the first candidate group posture.

If the at least two circular regions 302 include a circular region that is located in an unavailable region (for example, a region blocked by a landform, an object, or a virtual character) in the virtual environment, application error information is prompted to the user, to notify the user that positions of the at least two circular regions need to be changed. For example, colors of the at least two circular regions 302 are displayed as red.

Each candidate group posture corresponds to a central reference point 303, and the user may observe a position and an orientation of the central reference point 303 in the virtual environment. The orientation of the central reference point 303 is a reference orientation of a group posture corresponding to the candidate posture.

After the at least two circular regions 302 are placed in the virtual environment, a posture option list for the virtual character is displayed, where the list includes at least one of at least one preset posture option and at least one generated posture option. The preset posture option is a posture option provided by the application program, and the generated posture option includes at least one of a posture option corresponding to a customized posture edited by the first account or a posture option corresponding to a customized posture edited by another account.

The user may perform a selection operation on a posture option in the posture option list, to edit a posture of a virtual character in a circular region, or edit postures of virtual characters in a plurality of circular regions through one click.

After different virtual characters enter different circular regions of the at least two circular regions, postures corresponding to the different circular regions in which the different virtual characters are located are displayed. For example, after entering a circular region 3021, a virtual character 3041 is in a posture corresponding to the circular region 3021, after entering a circular region 3022, a virtual character 3042 is in a posture corresponding to the circular region 3022, and after entering a circular region 3023, a virtual character 3043 is in a posture corresponding to the circular region 3023.

The user may trigger a photographing function to photograph a group posture formed by postures corresponding to the virtual character 3041, the virtual character 3042, and the virtual character 3043.

The information (including, but not limited to, user equipment information, user personal information, and the like), data (including, but not limited to, data for analysis, stored data, displayed data, and the like), and signals involved described herein all are authorized by the user or fully authorized by each party, and the collection, use, and processing of relevant data need to comply with relevant laws and regulations of relevant countries and regions. For example, information involved described herein is obtained with full authorization. The terminal and the server cache the information only during operation of the program, and do not permanently store and reuse related data of the information.

FIG. 3 is a schematic flowchart of a virtual character posture editing method according to an illustrative aspect described herein. In this aspect, for example, the method is performed by a terminal shown in FIG. 1. The method includes at least some of the following operations:

Operation 310: Obtain at least one candidate group posture, each candidate group posture of the at least one candidate group posture corresponding to postures of at least two virtual characters.

The obtained at least one candidate group posture may be displayed on a display screen of the terminal.

The group posture is a combined posture formed by at least two virtual characters. The candidate posture includes: at least one of a preset group posture or a generated group posture. A candidate posture option includes: at least one of a preset group posture option or a generated group posture option.

The preset group posture is a group posture originally provided by an application program. The generated group posture includes at least one of a posture corresponding to a customized group posture edited by the first account or a posture corresponding to a customized group posture by another account.

In some aspects, the at least one candidate group posture may be displayed in a form of at least one of at least one candidate group posture option, at least one candidate group posture list, or at least one candidate group posture menu.

In some aspects, the at least one candidate group posture and the at least one candidate group option have the same meaning.

Each candidate group posture has corresponding positions of virtual characters (or understood as positions of circular regions) in the group, a number of virtual characters (or understood as a number of circular regions) in the group, and postures of the virtual characters in the group.

Postures of virtual characters in a group may be individually edited or may be uniformly edited. Postures of virtual characters in a group may be default/preset postures or may be postures customized by a user.

In some aspects, at least one posture is displayed, and postures of one or more virtual characters in a group are switched in response to a selection operation on the at least one posture.

In some aspects, the at least one posture is displayed in a form of posture option, posture list, or posture menu.

Operation 330: Display, in a virtual environment in response to a selection operation on a first group posture of the at least one candidate group posture, at least two circular regions corresponding to the first group posture.

The circular regions corresponding to the first group posture are in a one-to-one correspondence with postures in the first group posture.

In some aspects, a circular region sequence number is displayed in each circular region.

In some aspects, each circular region has at least one of a corresponding circular region sequence number, circular region color, and animation special effect, so that the user can distinguish between different circular regions.

In some aspects, the circular region sequence number is used to uniquely identify a current circular region in a management process of the at least two circular regions corresponding to the first group posture, and the management process includes at least one of a data storing process, a circular region adding process, and a circular region decreasing process.

Similarly, the circular region sequence number may be used to uniquely identify a current circular region in a management process of at least two circular regions corresponding to the second group posture, and the management process includes at least one of a data storing process, a circular region adding process, and a circular region decreasing process.

In some aspects, the at least two circular regions corresponding to the first group posture are displayed in the virtual environment by using a position of a first virtual character as a central reference point of the first group posture and using an orientation of the first virtual character as a reference orientation of the first group posture. The first virtual character is a virtual character whose control permission is possessed by the first account.

In some aspects, display of the at least two circular regions corresponding to the first group posture is refreshed in response to a change of the position of the first virtual character by using a position to which the first virtual character changes as a central reference point of the first group posture. Alternatively, display of the at least two circular regions corresponding to the first group posture is refreshed in response to a change of the orientation of the first virtual character by using an orientation to which the first virtual character changes as a reference orientation of the first group posture. Alternatively, display of the at least two circular regions corresponding to the first group posture is refreshed in response to a change of the position and the orientation of the first virtual character by using a position to which the first virtual character changes as a central reference point of the first group posture and using an orientation to which the first virtual character changes as a reference orientation of the first group posture.

In some aspects, at least two circular regions corresponding to a second group posture are displayed in the virtual environment in response to a selection operation on the second group posture of the at least one candidate group posture by using the position of the first virtual character as a central reference point of the second group posture and using the orientation of the first virtual character as a reference orientation of the second group posture.

In some aspects, the at least two circular regions of the first group posture and the at least two circular regions of the second group posture are displayed by using different display parameters.

In some aspects, the central reference point of the first group posture is the same as or different from the central reference point of the second group posture.

Illustratively, colors of the at least two circular regions of the first group posture are different from colors of the at least two circular regions of the second group posture. Alternatively, animation special effects of the at least two circular regions of the first group posture are different from animation special effects of the at least two circular regions of the second group posture. Alternatively, circular region sequence numbers of the at least two circular regions of the first group posture are different from circular region sequence numbers of the at least two circular regions of the second group posture.

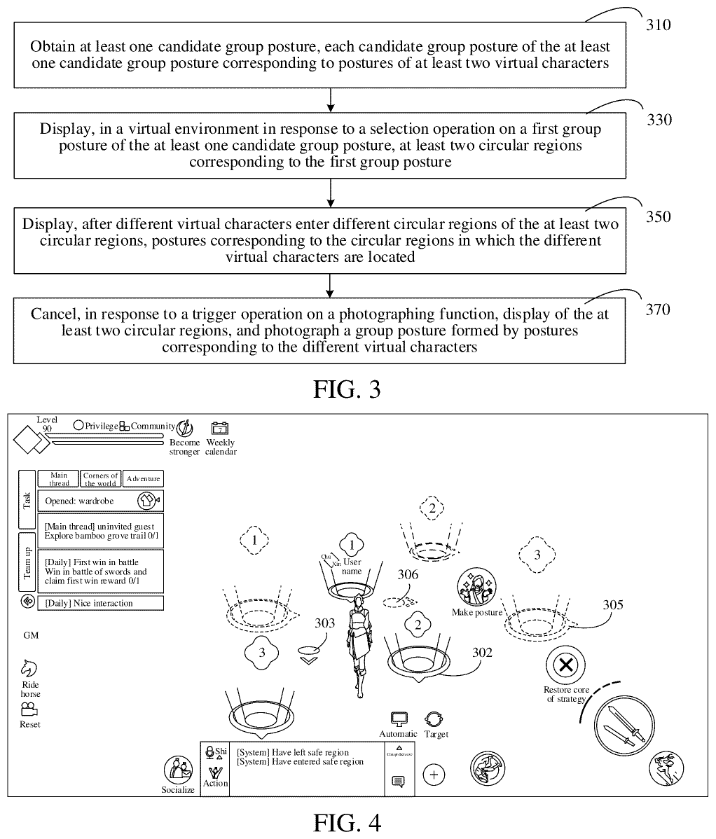

Illustratively, as shown in FIG. 4, at least two circular regions 302 of a first group posture and at least two circular regions 305 of a second group posture are displayed through different elements. A position of a central reference point 303 of the first group posture is different from a position of a central reference point 306 of the second group posture. An orientation of the central reference point 303 of the first group posture is different from an orientation of the central reference point 306 of the second group posture.

In some aspects, when the at least two circular regions include a circular region that is located in an unavailable region (for example, a region blocked by a landform, an object, or a virtual character) in the virtual environment, application error information is prompted to the user, to notify the user that positions of the at least two circular regions need to be changed. For example, colors of the at least two circular regions are displayed as red. For another example, text prompt information is displayed.

In some aspects, a whitelist position list exists in the application program, and a position that is not in the whitelist position list is an unavailable region.

Operation 350: Display, after different virtual characters enter different circular regions of the at least two circular regions, postures corresponding to the circular regions in which the different virtual characters are located.

The posture corresponding to the circular region includes a body posture and a body orientation that correspond to the circular region. The body posture may be a preset posture or may be a customized posture. The body orientation may be a preset orientation or may be a customized orientation.

In some aspects, the first virtual character is controlled to enter a first circular region of the at least two circular regions, and the first virtual character is controlled to apply, in the first circular region, a first posture corresponding to the first circular region.

In some aspects, a posture application control corresponding to the first circular region is displayed in a case that the first virtual character moves to a peripheral range of the first circular region. For example, after the first virtual character enters or approaches the first circular region, the posture application control is displayed. The posture corresponding to the first circular region is applied to the first virtual character in response to a trigger operation on the posture application control, and the first posture corresponding to the first circular region in which the first virtual character is located is displayed.

In some aspects, an application invitation for joining the first group posture is sent to the second account. Alternatively, an application invitation for joining the first group posture is sent to a specified group, where the specified group includes the second account.

In some aspects, prompt information indicating that the second account accepts the application invitation is displayed, or prompt information indicating that the second account rejects the application invitation is displayed.

In some aspects, that a second virtual character enters a second circular region of the at least two circular regions is displayed, and that the second virtual character applies, in the second circular region, a second posture corresponding to the second circular region is displayed. The second virtual character is a virtual character whose control permission is possessed by the second account.

In some aspects, a posture corresponding to the candidate group posture has a display time limit, and when the display time limit reaches, display of all circular regions, a central reference point, circular region sequence numbers, postures, and the like corresponding to the candidate group posture is automatically canceled.

In some aspects, in response to that a status of the first virtual character changes, display of the first posture corresponding to the first circular region in which the first virtual character is located is canceled.

In some aspects, that the status of the first virtual character changes includes at least one of the following: a body position of the first virtual character changes; a body posture of the first virtual character changes; a body orientation of the first virtual character changes; the first virtual character enters an attacked status; and the first virtual character enters a teleportation status.

In some aspects, in response to a trigger operation on the posture application control, display of the first posture corresponding to the first circular region in which the first virtual character is located is canceled.

Operation 370: Cancel, in response to a trigger operation on a photographing function, display of the at least two circular regions, and photograph a group posture formed by postures corresponding to the different virtual characters.

In some aspects, the application program provides a photographing function. For example, a photographing control is displayed on an interface. After the user triggers the photographing function, display of all circular regions corresponding to all currently selected candidate group postures is canceled. In some aspects, display of a candidate group posture option, a group posture list, and central reference points, circular region sequence numbers, posture options, posture lists, and the like of all currently selected candidate group postures may also be canceled.

Postures corresponding to different virtual characters include body postures, body positions, and body orientations corresponding to the different virtual characters.

In conclusion, in the method provided in the aspects described herein, after different virtual characters enter circular regions corresponding to a candidate group posture, postures corresponding to the circular regions can be quickly displayed, thereby reducing a large number of operations in an editing process of a group posture and reducing a large number of operations in a display process of a group posture. For an electronic device with limited operation manners, such as a mobile phone or a tablet computer, human computer operation costs of a user can be reduced, and a group posture corresponding to a plurality of virtual characters can be displayed more easily and more quickly with fewer human computer operations, so that a group image of the plurality of virtual characters is displayed according to a candidate group posture. In addition, at least one group posture can be conveniently placed in the virtual environment based on an orientation and a position of the first virtual character. When a placement manner needs to be adjusted, the group posture can be adjusted simply by adjusting the orientation and the position of the first virtual character. A quick, accurate, and convenient UGC generation, application, and sharing solution for a group posture is implemented.

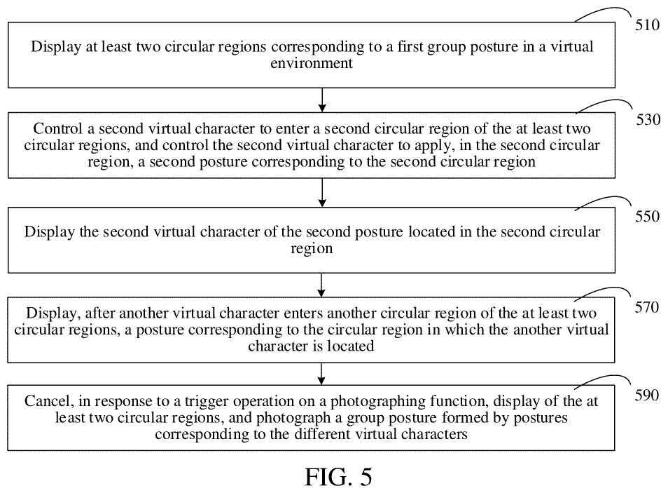

FIG. 5 is a schematic flowchart of a virtual character posture editing method according to an illustrative aspect described herein. In this aspect, for example, the method is performed by a terminal shown in FIG. 1.

Operation 510: Display, in a virtual environment, at least two circular regions corresponding to a first group posture.

The first group posture corresponds to postures of at least two virtual characters. The first group posture is placed by a first account in the virtual environment. The at least two circular regions are in a one-to-one correspondence with postures of the at least two virtual characters.

In some aspects, a circular region sequence number is displayed in each circular region.

In some aspects, each circular region has at least one of a corresponding circular region sequence number, circular region color, and animation special effect, so that the user can distinguish between different circular regions.

In some aspects, in response to that a position of a first virtual character changes, positions of the at least two circular regions corresponding to the first group posture change. Alternatively, in response to that an orientation of the first virtual character changes, an orientation of the first group posture changes. Alternatively, in response to that the position and the orientation of the first virtual character change, positions and orientations of the at least two circular regions corresponding to the first group posture change.

In some aspects, at least two circular regions corresponding to a second group posture are further displayed in the virtual environment. The second group posture corresponds to postures of at least two virtual characters. The second group posture is placed by the first account in the virtual environment. The at least two circular regions are in a one-to-one correspondence with postures of the at least two virtual characters.

In some aspects, the at least two circular regions of the first group posture and the at least two circular regions of the second group posture are displayed by using different display parameters.

In some aspects, the central reference point of the first group posture is the same as or different from the central reference point of the second group posture.

Illustratively, colors of the at least two circular regions of the first group posture are different from colors of the at least two circular regions of the second group posture. Alternatively, animation special effects of the at least two circular regions of the first group posture are different from animation special effects of the at least two circular regions of the second group posture. Alternatively, circular region sequence numbers of the at least two circular regions of the first group posture are different from circular region sequence numbers of the at least two circular regions of the second group posture.

Operation 530: Control a second virtual character to enter a second circular region of the at least two circular regions, and control the second virtual character to apply, in the second circular region, a second posture corresponding to the second circular region.

In some aspects, a posture application control corresponding to the second circular region is displayed in a case that the second virtual character moves to a peripheral range of the second circular region. For example, after the second virtual character enters or approaches the second circular region, the posture application control is displayed. By triggering the posture application control, the second virtual character may be controlled to apply, in the second circular region, the second posture corresponding to the second circular region, or the second virtual character may be controlled not to apply, in the second circular region, the second posture corresponding to the second circular region.

When different virtual characters enter different circular regions, postures that correspond to the circular regions and that the virtual characters entering the circular regions make may be displayed, so that the virtual characters may pre-select suitable circular regions, thereby improving an effect of group image display in a group posture.

In some aspects, when the second account and the first account belong to the same group, if the first account places the first group posture in the virtual environment, a client in which the second account is logged into automatically displays, in the virtual environment, at least two circular regions corresponding to the first group posture.

In some aspects, the second account receives an application invitation that is sent by the first account and that is for joining the first group posture. Alternatively, the second account receives, in a specified group, an application invitation that is sent by the first account and that is for joining the first group posture, where the specified group includes the second account.

In some aspects, prompt information indicating that the second account accepts the application invitation is displayed, or prompt information indicating that the second account rejects the application invitation is displayed.

In some aspects, in response to an operation performed by the second account to accept the application invitation for joining the first group posture, the client in which the second account is logged into displays, in the virtual environment, the at least two circular regions corresponding to the first group posture.

The application invitation can be used to avoid that an unwanted virtual character enters a circular region at will and affects a display effect of a group posture.

Operation 550: Display the second virtual character of the second posture located in the second circular region.

The posture corresponding to the second circular region is applied to the second virtual character in response to a trigger operation on the posture application control, and the second posture corresponding to the second circular region in which the second virtual character is located is displayed.

In some aspects, the first group posture has a display time limit, and when the display time limit reaches, display of all circular regions, a central reference point, circular region sequence numbers, postures, and the like corresponding to the first group posture is automatically canceled.

In some aspects, in response to that a status of the second virtual character changes, display of the second posture corresponding to the second circular region in which the second virtual character is located is canceled.

In some aspects, that the status of the second virtual character changes includes at least one of the following: a body position of the second virtual character changes; a body posture of the second virtual character changes; a body orientation of the second virtual character changes; the second virtual character enters an attacked status; and the second virtual character enters a teleportation status.

In some aspects, in response to a trigger operation on the posture application control, display of the second posture corresponding to the second circular region in which the second virtual character is located is canceled.

The posture application control is displayed when a circular region is approached, so that an effective prompt function can be implemented. In response to a trigger operation on the posture application control, the second virtual character is controlled to make a corresponding gesture or exit the gesture, so that a control party of the second virtual character can intuitively view the gesture and properly select.

Operation 570: Display, after another virtual character enters another circular region of the at least two circular regions, a posture corresponding to the circular region in which the another virtual character is located.

The another virtual character is one or more virtual characters other than the second virtual character in the virtual environment. If the second circular region belongs to the at least two circular regions corresponding to the first group posture, the another circular region is one or more circular regions of the at least two circular regions corresponding to the first group posture other than the second circular region. If the second circular region belongs to the at least two circular regions corresponding to the second group posture, the another circular region is one or more circular regions of the at least two circular regions corresponding to the second group posture other than the second circular region.

Operation 590: Cancel, in response to a trigger operation on a photographing function, display of the at least two circular regions, and photograph a group posture formed by postures corresponding to the different virtual characters.

In some aspects, the application program provides a photographing function. For example, a photographing control is displayed on an interface. After the user triggers the photographing function, display of all circular regions corresponding to all currently selected candidate group postures is canceled. In some aspects, display of a candidate group posture option, a group posture list, and central reference points, circular region sequence numbers, posture options, posture lists, and the like of all currently selected candidate group postures may also be canceled.

Postures corresponding to different virtual characters include body postures, body positions, and body orientations corresponding to the different virtual characters.

In different aspects, in response to a selection operation on at least one candidate group posture, the selected candidate group posture is presented in the virtual environment, or the selected candidate group posture is presented on a personal character panel of a user, or the selected candidate group posture is presented in a specified group, or the selected candidate group posture is presented in a chat scene.

In different aspects, the user may further set a presentation moment, a presentation duration, and a presentation range of the selected candidate group posture. Illustratively, the user sets that the candidate group posture is automatically presented from 9 o'clock to 11 o'clock every day. Illustratively, the user sets that the candidate group posture is only presented to a friend account.

In different aspects, in response to a selection operation performed by the first account on at least one candidate group posture, the first account applies the selected candidate group posture in the virtual environment, or the first account and another account apply the selected candidate group posture.

In different aspects, in response to a selection operation performed by the first account on at least one candidate group posture, the first account shares the selected candidate group posture with another account. The another account may perform at least one of a storing operation, an editing operation, a sharing operation, an application operation, or the like on the candidate group posture.

In conclusion, in the method provided in the aspects described herein, after different virtual characters enter circular regions corresponding to a candidate group posture, postures corresponding to the circular regions can be quickly displayed, thereby reducing a large number of operations in an editing process of a group posture and reducing a large number of operations in a display process of a group posture. For an electronic device with limited operation manners, such as a mobile phone or a tablet computer, human computer operation costs of a user can be reduced, and a group posture corresponding to a plurality of virtual characters can be displayed more easily and more quickly with fewer human computer operations. In addition, a user can perform a plurality of operations on the candidate group posture, for example, a sharing operation, an application operation, a presentation operation, and an editing operation, so that the method provided in this aspect described herein is highly flexible, interesting, and interactive and effectively improves user experience.

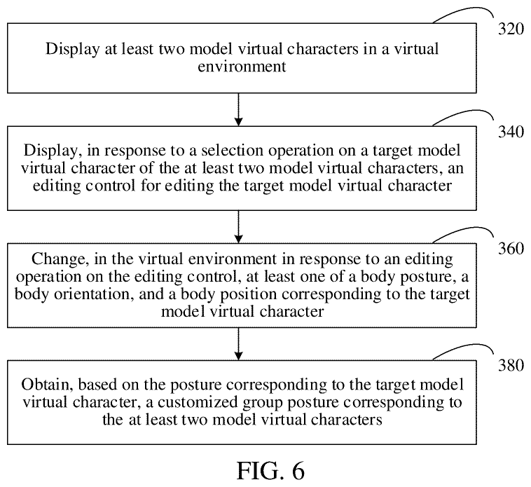

FIG. 6 is a schematic flowchart of a virtual character posture editing method according to an illustrative aspect described herein. In this aspect, for example, the method is performed by a terminal shown in FIG. 1.

The method may be applied after operation 330, that is, after the at least two circular regions corresponding to the first group posture are displayed in the virtual environment, some or all of operations shown in FIG. 6 are performed.

Alternatively, the method may be applied before operation 310 and operation 330, that is, some or all of the operations shown in FIG. 6 are first performed, and then the at least one candidate group posture is obtained or the at least two circular regions corresponding to the first group posture are displayed in the virtual environment.

The method includes at least some of the following operations:

Operation 320: Display at least two model virtual characters in a virtual environment.

A terminal runs an application program that support the virtual environment, where the application program can be a game client or a social client (for example, a metaverse social program). One or more virtual characters are provided in the application program. User accounts control different virtual characters to perform game battle or virtual socializing. Different user accounts may form at least one of a friend relationship, a group relationship, a temporary group relationship, and the like.

For example, the application program is a game client. Illustratively, the game client includes a virtual character controlled by a user and a virtual character not controlled by a user. The virtual character controlled by the user may be presented on a presentation interface of the virtual character for the user to view. When the virtual character is presented, a posture of the virtual character may be a posture preset in the game client. However, in this aspect described herein, the user may customize postures of a plurality of virtual characters.

If a user intends to customize postures of a plurality of virtual characters, the user performs a group posture creation operation in the game client, to trigger a group posture creation request. A terminal displays a group posture editing interface in response to the group posture creation request. The group posture editing interface is used for editing a group posture of model virtual characters. The group posture editing interface includes at least two model virtual characters in the virtual environment. The user performs posture editing on the model virtual characters.

The model virtual character is a virtual character as a model during group posture editing. The model virtual character may be one of a plurality of candidate model virtual characters. The plurality of candidate model virtual characters may be classified according to factors such as body shape, gender, and age. For example, virtual characters of three body shapes are provided, and the plurality of candidate model virtual characters include: a first model virtual character corresponding to an adult male, a second model virtual character corresponding to an adult female, a third model virtual character corresponding to a body shape of a teenage female, and a virtual character controlled by a current user (one of the three body shapes+personalized face+personalized clothes).

Operation 340: Display, in response to a selection operation on a target model virtual character of the at least two model virtual characters, an editing control for editing the target model virtual character.

After one or more model virtual characters are selected from the at least two model virtual characters, the editing control for editing the target model virtual character is displayed. The target model virtual character is a model virtual character selected from the at least two model virtual characters.

The editing control may be configured to change at least one of a body posture, a body orientation, or a body position corresponding to the target model virtual character in the virtual environment.

In some aspects, the editing control includes: at least one of a body orientation editing control, a body position editing control, or a body posture editing control.

The body orientation editing control is configured to control an orientation of the target model virtual character in the virtual environment. The body position editing control is configured to control a position of the target model virtual character in the virtual environment. The body posture editing control is configured to control a posture of a specified body part of the target model virtual character in the virtual environment.

In some aspects, the body posture editing control includes: at least one of a body part orientation controlling control, a body part posture control, and an orientation reference object control.

In some aspects, the editing control includes: an entire application control (refer to a control 71 in FIG. 16). In response to a trigger operation on the entire application control, at least one of a body posture, a body orientation, and a body position corresponding to the target model virtual character is applied to all model virtual characters in a group posture editing interface 20.

In some aspects, body postures corresponding to at least two model virtual characters in the group posture editing interface are uniformly changed based on the body posture corresponding to the target model virtual character.

In some aspects, local body part postures corresponding to at least two model virtual characters in the group posture editing interface are uniformly changed based on a local body part posture corresponding to the target model virtual character.

In some aspects, body orientations corresponding to at least two model virtual characters in the group posture editing interface are uniformly changed based on the body orientation corresponding to the target model virtual character.

In some aspects, the body orientation corresponding to the model virtual character may be understood as a circular region orientation corresponding to the model virtual character.

In some aspects, local body part orientations corresponding to at least two model virtual characters in the group posture editing interface are uniformly changed based on a local body part orientation corresponding to the target model virtual character.

In different aspects, body positions, body orientations, and local body part orientations of different model virtual characters in the group posture editing interface are different. When local body part orientations corresponding to at least two model virtual characters in the group posture editing interface are uniformly changed, for example, when different model virtual characters are uniformly set to “watch camera”, although sight lines of the different model virtual characters all watch the camera, sight line orientations of the different model virtual characters are still different.

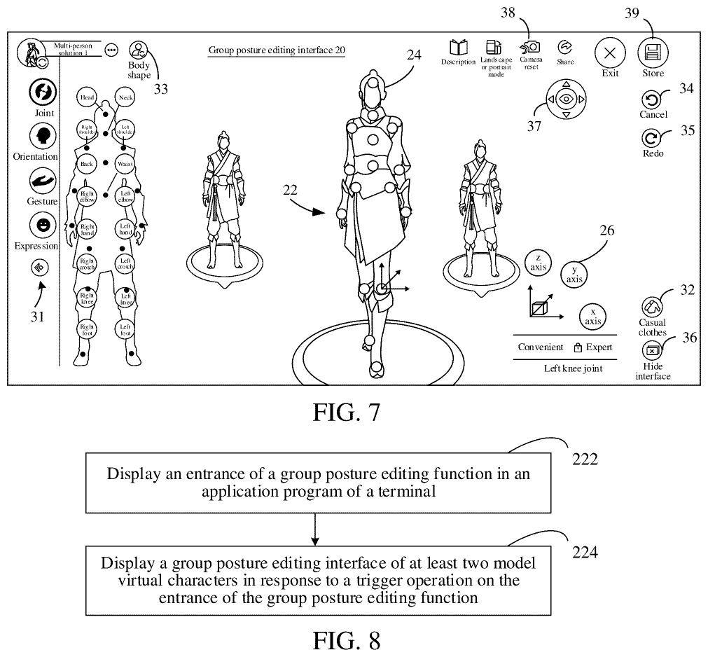

Illustratively, a schematic diagram of the body posture editing control may be shown in FIG. 7. A plurality of menu items 31 are displayed on a left side of a group posture editing interface 20: joint, orientation, gesture, and expression. The joint menu is configured to open an editing control related to a skeleton point. The orientation menu is configured to open an editing control related to a face orientation and an eye orientation. The gesture menu is configured to open an editing control related to a gesture. The expression menu is configured to open an editing control related to an expression.

A body posture of the target model virtual character may be edited based on various body posture editing controls shown in FIG. 7. The user may edit postures of different skeleton points, that is, edit postures of different body parts, to adjust the posture of the target model virtual character to a desired customized posture.

Operation 360: Change, in the virtual environment in response to an editing operation on the editing control, at least one of a body posture, a body orientation, and a body position corresponding to the target model virtual character.

In response to an editing operation on the editing control, the posture of the target model virtual character is controlled to change, where the posture includes at least one of a body posture, a body orientation, and a body position, so that the target model virtual character is in a customized posture.

Operation 380: Obtain, based on the posture corresponding to the target model virtual character, a customized group posture corresponding to the at least two model virtual characters.

The user performs a posture editing operation on the target model virtual character in the group posture editing interface, and the terminal controls, based on the posture editing operation performed by the user, the posture of the target model virtual character to change as indicated by the posture editing operation. The changed target model virtual character is in a customized posture edited by the user. The customized posture is a posture obtained after the posture of the target model virtual character is changed based on at least one posture editing operation.

In different aspects, at least one of different body parts of the target model virtual character is edited, to change at least one of a body posture, a body orientation, and a body position of the target model virtual character. The different body parts include, but are not limited to: at least one of skeleton points (a joint and/or a skeleton), a gesture, an expression, a face orientation, and an eye orientation.

In different aspects, the user performs a posture editing operation on different target model virtual characters in the group posture editing interface, and the terminal controls, based on the posture editing operation performed by the user, at least two model virtual characters in the virtual environment to change as indicated by the posture editing operation. The changed at least two model virtual characters are in a customized group posture edited by the user. The customized group posture is a group posture obtained after postures of some or all of the at least two model virtual characters are changed based on at least one posture editing operation.

In some aspects, at least two model virtual characters are displayed in a one-to-one correspondence with at least two circular regions. The user may perform at least one of the following operations: increasing circular regions to increase a number of model virtual characters, and reducing circular regions to reduce a number of model virtual characters in the virtual environment.

In some aspects, the circular region may be understood as a position in which a model virtual character is located, or a spatial range in which the model virtual character is located, or a region to which the model virtual character belongs.

In some aspects, group posture data for applying the customized posture to virtual characters controlled by at least two accounts is generated based on the customized group posture presented by at least two model virtual characters.

In some aspects, after the postures of the at least two model virtual characters reach the expectation of the user, the user stops performing the group posture editing operation, and performs a group posture generation operation on the at least two model virtual characters, to trigger a group posture generation request. In response to the group posture generation request, the terminal generates group posture data of the customized group posture based on the at least two model virtual characters in the customized group posture, where the group posture data is used for indicating the customized group posture.

In some aspects, the group posture data may be absolute group posture data or relative group posture data. The absolute group posture data refers to skeleton data of the customized group posture in the virtual environment. The relative group posture data is used to indicate a skeleton offset value of the customized group posture relative to an initial group posture.

The posture data and attached information of the customized group posture are stored as a posture work of the customized group posture. The attached information includes: at least one piece of information of account information of a creator, a creation time, personalized information of a model virtual character, body shape information of a model virtual character, posture data of an initial group posture of a model virtual character, a name of the customized group posture, and a preview image of the customized group posture.

The posture work of the customized group posture may be applied to a virtual character controlled by the first account, or may be shared by the first account with the another account and applied to a virtual character controlled by the another account. Therefore, the customized group posture is used as a type of UGC content to be shared and applied between accounts.

In conclusion, according to the method provided in this aspect described herein, an editing control of a target model virtual character is provided for a player, and at least one of body postures, body orientations, and body positions corresponding to at least two model virtual characters is changed to obtain a customized group posture including a plurality of virtual characters, so that a plurality of virtual characters controlled by a plurality of users present a group image according to the customized group posture. Therefore, a quick, accurate, and convenient UGC generation, application, and sharing solution for a group posture is implemented.

### 1. Entrance of Group Posture Editing Function

FIG. 8 is a schematic flowchart of a method for enabling an editing function for a group posture according to an illustrative aspect described herein. In this aspect, for example, the method is performed by a terminal. The method includes:

Operation 222: Display an entrance of a group posture editing function in an application program of a terminal.

Assuming that a first account is logged into in the application program, a user controls, in the application program, a first virtual character corresponding to the first account to perform various activities. The application program provides a plurality of functions, and the plurality of functions include, but are not limited to: a battle function, task execution, transaction, communication, and the like. In this aspect, the application program provides the entrance of the group posture editing function.

There are one or more entrances of the group posture editing function.

Illustratively, the entrance of the group posture editing function includes, but is not limited to at least one of the following:
a first entrance of a group posture editing function for creating new editing based on a preset group posture in a system; and
a second entrance of a group posture editing function for re-editing based on a created group posture.

Operation 224: Display a group posture editing interface of at least two model virtual characters in response to a trigger operation on the entrance of the group posture editing function.

The trigger operation is at least one of a click operation, a double-click operation, a press operation, a slide operation, a voice control operation, and an eye control operation.

The group posture editing interface of the at least two model virtual characters is displayed in response to the trigger operation on the entrance of the group posture editing function. The group posture editing interface includes: at least two model virtual characters in a virtual environment and at least one editing control.

In some aspects, the virtual environment is an independent virtual environment dedicated to group posture editing. The virtual environment is different from a virtual world of a virtual character during daily activities. In some aspects, the virtual environment may alternatively be a part of a virtual world of a virtual character during daily activities, for example, in a courtyard or a house.

In some aspects, the virtual environment may be subject to at least one of rotation, reduction, enlarging, zooming out, zooming in, and visual angle translation.

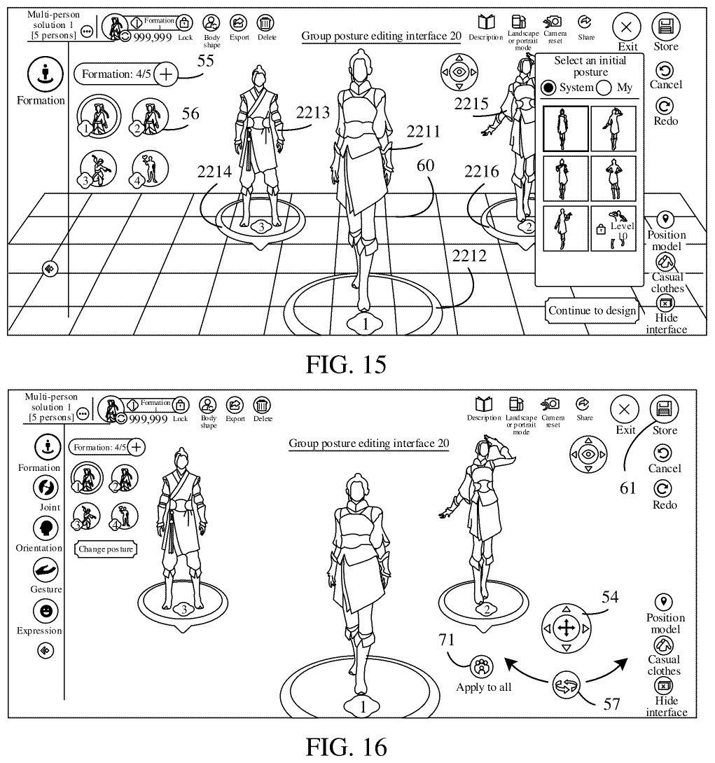

In some aspects, a ground grid (refer to a grid 60 shown in FIG. 15) is displayed in the group posture editing interface. The ground grid is used for indicating a spatial range for group posture customization, and bodies of the at least two model virtual characters cannot exceed the spatial range indicated by the ground grid. In some aspects, the ground grid displays a grid center, and the grid center may indicate an orientation of the spatial range. In some aspects, when posture editing is performed on a target model virtual character, the grid center may be used as a reference point, and position information corresponding to at least two model virtual characters relative to the grid center may be obtained.

In some aspects, a display mode of the group posture editing interface may be switched between landscape mode and portrait mode. In some aspects, based on change of the display mode, at least one of sizes, positions, layouts, and the like of the at least two model virtual characters and the editing control in the group posture editing interface also changes.

In some aspects, when the entrance is the first entrance, initial postures of the at least two model virtual characters are default postures, for example, a standing posture with two hands hanging down. When the entrance is the second entrance, initial postures of the at least two model virtual characters are created postures.

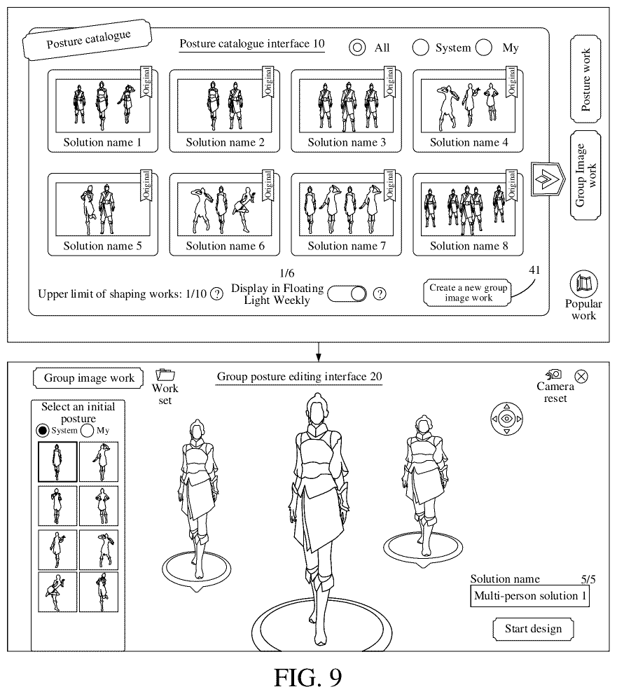

Illustratively, referring to FIG. 9, group image work creation 41 is displayed on a posture catalogue interface 10 of an application program. The group image work creation 41 is the first entrance of a posture editing function for creating editing based on a preset posture in a system. In response to a trigger operation on the group image work creation 41, a group posture editing interface 20 of at least two model virtual characters is displayed. In the group posture editing interface 20, initial postures of the at least two model virtual characters are default postures.

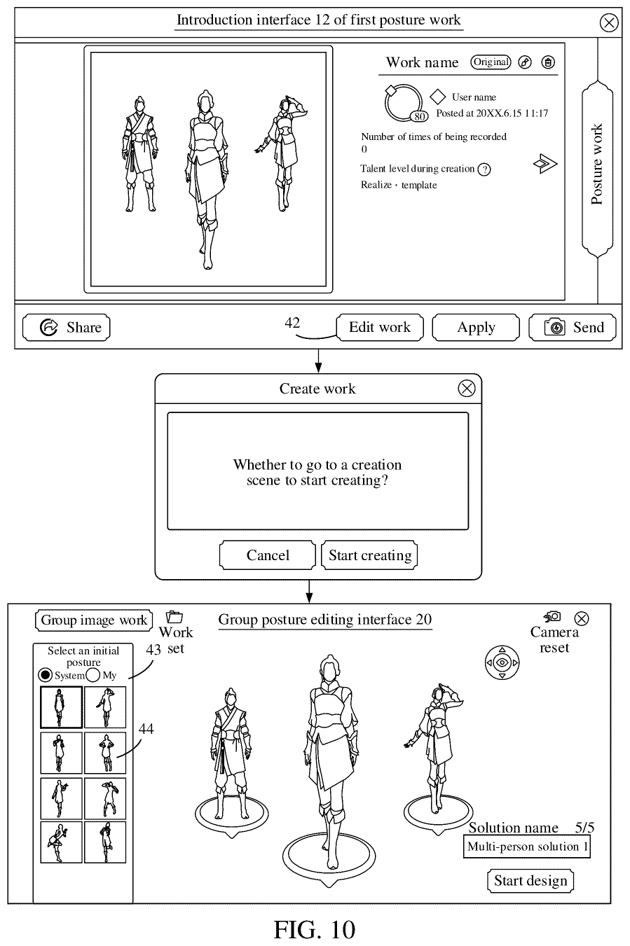

Illustratively, referring to FIG. 10, a created gesture work is displayed in the gesture catalogue interface 10 of the application program. In response to a selection operation on a first posture work, an introduction interface 12 of the first posture work is displayed. The first posture work is a posture work created by the first account or another account. An editing button 42 is displayed on the introduction interface 12 of the first posture work. The editing button 42 is the second entrance of a posture editing function for re-editing based on a created posture. In response to a trigger operation on the editing button 42, a group posture editing interface 20 of at least two model virtual characters is displayed. In the group posture editing interface 20, postures of the at least two model virtual characters are a posture corresponding to the first posture work. In some aspects, re-editing can be started only after a user confirms the editing, to avoid a misoperation of the user.

Illustratively, referring to FIG. 7, several general function buttons are further displayed on the group posture editing interface 20 illustratively as follows:
Casual clothes button 32.

The target model virtual character 22 in the group posture editing interface 20 is displayed based on a skeleton model and clothes attached on the skeleton model. By default, the clothes attached on the skeleton model are a long garment.

The long garment on the target model virtual character 22 is replaced with underwear in response to a selection operation on the casual clothes button 32, so as to expose body parts of the model virtual character 22, and facilitate the user to view skeleton change of the skeleton model of the target model virtual character 22 during group posture editing. The underwear on the target model virtual character 22 is replaced with the long garment in response to a de-selection operation on the casual clothes button 32, so as to facilitate the user to view entire posture change of the target model virtual character 22 during group posture editing.
Body shape switching button 33.

The group posture editing interface 20 further provides a plurality of candidate model virtual characters, and body shapes corresponding to the candidate model virtual characters may be different. In this aspect, for example, three body shapes are provided, and the plurality of candidate model virtual characters include: a first model virtual character corresponding to an adult male, a second model virtual character corresponding to an adult female, a third model virtual character corresponding to a body shape of a teenage female, and a virtual character controlled by a user (one of the three body shapes+personalized face+personalized clothes).

In some aspects, the target model virtual character 22 in the group posture editing interface 20 is switched to a model virtual character of another body shape in response to a trigger operation on the body shape switching button 33.

In some aspects, a plurality of candidate model virtual characters are displayed in response to a trigger operation on the body shape switching button 33. In response to a selection operation on one of the plurality of candidate model virtual characters, the target model virtual character 22 in the group posture editing interface 20 is switched to the selected model virtual character.
Cancellation button 34 and restoration button 35.

A last group posture editing operation is canceled in response to a trigger operation on the cancellation button 34. A last canceled group posture editing operation is restored in response to a trigger operation on the restoration button 35.
Hiding button 36.

In response to a trigger operation on the hiding button 36, all or some of the plurality of editing controls are hidden, so as to provide more presentation space for the target model virtual character 22 in the group posture editing interface 20.
Camera controlling control 37.

An image of the target model virtual character 22 in the virtual environment is captured by a virtual camera model (briefly referred to as a camera). FIG. 11 is a schematic diagram of a working principle of a camera model in a virtual environment according to an aspect described herein. The schematic diagram shows a process of mapping a feature point P in a virtual environment 201 to a feature point p′ in an imaging plane 203. Coordinates of the feature point P in the virtual environment 201 are in a three-dimensional form, and coordinates of the feature point p′ in the imaging plane 203 are in a two-dimensional form. The virtual environment 201 is a virtual environment corresponding to a virtual world. A camera plane 202 depends on a posture of a camera model, the camera plane 202 is a plane perpendicular to a photographing direction of the camera model, and the imaging plane 203 and the camera plane 202 are parallel to each other. The imaging plane 203 is a plane of a virtual environment within a field of view during imaging by the camera model when the virtual environment is observed.

The camera controlling control 37 is configured to control a position of the camera in the virtual environment. For example, the camera controlling control 37 is a joystick. In response to a dragging operation performed on the joystick 37 in at least one of upward, downward, leftward, and rightward directions, the camera is controlled to move in a corresponding direction in the virtual environment.

In some aspects, in response to an upward sliding operation at the blank of the group posture editing interface 20, the camera is controlled to rotate upwards in the virtual environment. In response to a downward sliding operation at the blank of the group posture editing interface 20, the camera is controlled to rotate downwards in the virtual environment. In response to a leftward sliding operation at the blank of the group posture editing interface 20, the camera is controlled to rotate leftwards in the virtual environment. In response to a rightward sliding operation at the blank of the group posture editing interface 20, the camera is controlled to rotate rightwards in the virtual environment.

In some aspects, in response to a two-finger zoom operation, a mouse scrolling zoom operation, or a key zoom operation at the blank of the group posture editing interface 20, the camera is controlled to move forwards or move backwards in the virtual environment, to zoom in or zoom out the target model virtual character in the virtual environment.

In some aspects, the camera controlling control 37 is displayed in a form of floating joystick. Some editing controls in the group gesture editing interface 20 are displayed by using a floating window. When the floating window is dragged to a position of the camera controlling control 37, the camera controlling control 37 adaptively moves to another idle position in the group posture editing interface 20.
Camera reset button 38.

Because the user may change a camera position for a plurality of times, in response to a trigger operation on the camera reset button, the camera position is quickly reset to a default initial position. Illustratively, the default initial position of the camera is a front center position of a model virtual character.

In some aspects, a single-person mode and a multi-person mode respectively need default camera configurations, and configuration parameters in the two default camera configurations are different.

### 2. Manner of Determining Initial Formation

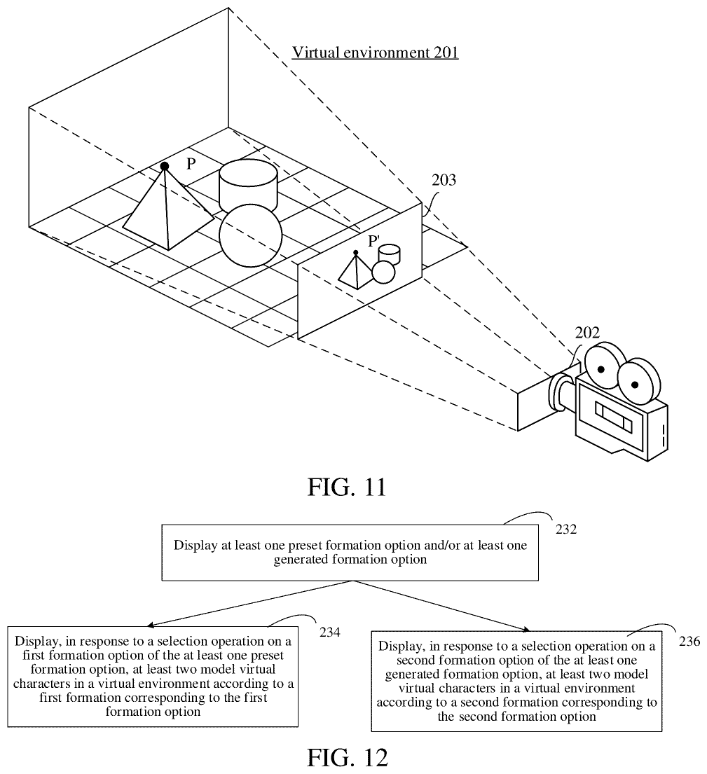

FIG. 12 is a schematic flowchart of an initial formation setting method according to an illustrative aspect described herein. In this aspect, for example, the method is performed by a terminal. The method includes:

Operation 232: Display at least one of at least one preset formation option and at least one generated formation option.

In some aspects, one formation option corresponds to at least one of the following: a starting number of virtual characters in a formation, and position distribution of at least two virtual characters in the formation.

In some aspects, one formation option corresponds to at least one of the following: a starting number of circular regions in a formation, and position distribution of at least two circular regions in the formation.

In some aspects, the formation has a central position, and each circular region in the formation is placed by using the central position as a reference point. The central position may also be referred to as a central reference point.

The preset formation option is a formation option originally provided by the application program, and the generated formation option includes at least one of a formation option corresponding to a customized formation edited by the first account or a formation option corresponding to a customized formation edited by another account.

In some aspects, the at least one generated formation option is a formation option corresponding to a customized formation collected by the first account.

Illustratively, as shown in FIG. 10, an initial formation selection control 53 is displayed in the group posture editing interface 20. The initial formation selection control 53 has two menu bars: a first menu bar “system” for triggering to display at least one preset formation option in the initial formation selection control 53, and a second menu bar “my” for triggering to display at least one generated formation option in the initial formation selection control 53. The second menu bar may also be referred to as a “work”, and is used for triggering to display some or all formation options in a work set of the current account in the initial formation selection control 53.

In some aspects, when the group posture editing interface 20 is entered, the initial formation selection control 53 is in a display status by default. The display of the initial formation selection control is canceled after the user selects an initial formation option. During subsequent editing, the initial formation selection control 53 is switched from a hiding status to the display status in response to a display operation on the initial formation selection control 53. The initial formation selection control 53 is switched from the display status to the hiding status in response to a hiding operation on the initial formation selection control 53.

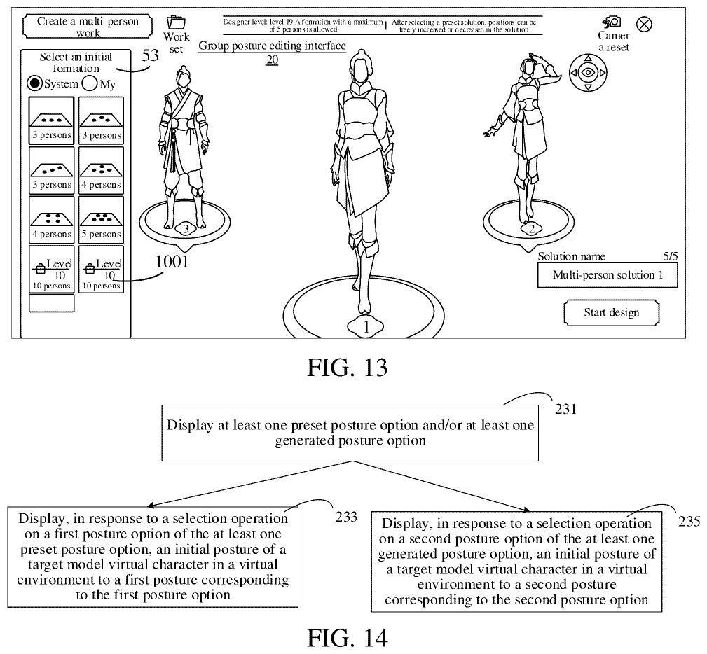

Illustratively, as shown in FIG. 13, at least one preset formation option 1001 includes: a two-person formation (including one or more position distributions), a three-person formation (including one or more position distributions), a four-person formation (including one or more position distributions), a five-person formation (including one or more position distributions), a ten-person formation (including one or more position distributions), and the like.

Operation 234: Display, in response to a selection operation on a first formation option of the at least one preset formation option, at least two model virtual characters in a virtual environment according to a first formation corresponding to the first formation option.

In some aspects, the first formation option correspondingly stores formation data corresponding to the first formation. The formation data corresponding to the first formation is imported into skeleton models of the at least two model virtual characters, so as to set initial formations of the at least two model virtual characters in the virtual environment to the first formation corresponding to the first formation option.

In some aspects, the group gesture editing interface displays a “quick replacement” control. In response to a trigger operation on the “quick replacement” control, a default model virtual character in a selected circular region is replaced with a model virtual character posture in the preset posture option.

Operation 236: Display, in response to a selection operation on a second formation option of the at least one generated formation option, at least two model virtual characters in a virtual environment according to a second formation corresponding to the second formation option.

In some aspects, the second formation option correspondingly stores formation data corresponding to the second formation. The formation data corresponding to the second formation is imported into skeleton models of the at least two model virtual characters, so as to set initial formations of the at least two model virtual characters in the virtual environment to the second formation corresponding to the second formation option.

In some aspects, the group gesture editing interface displays a “quick replacement” control. In response to a trigger operation on the “quick replacement” control, a default model virtual character in a selected circular region is replaced with a model virtual character posture in the generated posture option.

In some aspects, during group posture editing, the user may still modify the initial formations of the at least two model virtual characters. During switching to a next initial formation, if an initial formation before switching is already edited, switching to the next initial formation requires re-confirmation.

In some aspects, during group posture editing, the user may switch from a formation editing interface to a posture editing interface, or may switch from a posture editing interface to a formation editing interface.

In conclusion, according to the method provided in this aspect, at least one preset formation option preset in a system is provided, so that a user can use several basic preset formations as a start point for creating a customized formation, thereby reducing a large number of operations during group posture editing. For an electronic device with limited operation manners, such as a mobile phone or a tablet computer, human computer operation costs of a user can be reduced, and a more personalized customized formation can be created more easily with fewer human computer operations.

According to the method provided in this aspect, at least one generated formation option created by a current user and/or another user is further provided, so that the current user can use, as a start point for recreation, a customized formation generated by another user, and can add creativity based on creativity of another user, thereby facilitating generation of a customized formation combining creativity of different users.

### 3. Manner of Determining Initial Posture

FIG. 14 is a schematic flowchart of an initial posture setting method according to an illustrative aspect described herein. In this aspect, for example, the method is performed by a terminal. The method includes:

Operation 231: Display at least one of at least one preset posture option and at least one generated posture option.

The preset posture option is a posture option originally provided by the application program, and the generated posture option includes at least one of a posture option corresponding to a customized posture edited by the first account or a posture option corresponding to a customized posture edited by another account.

In some aspects, the at least one generated posture option is a posture option corresponding to a customized posture collected by the first account.

Illustratively, as shown in FIG. 7, an initial posture selection control 43 is displayed in the group posture editing interface 20. The initial posture selection control 43 has two menu bars: a first menu bar “system” for triggering to display at least one preset posture option in the initial posture selection control 43, and a second menu bar “my” for triggering to display at least one generated posture option in the initial posture selection control 43.

In some aspects, when the posture editing interface is entered, the initial posture selection control 43 is in a display status by default. The display of the initial posture selection control is canceled after the user selects an initial posture option. During subsequent editing, the initial posture selection control 43 is switched from a hiding status to the display status in response to a display operation on the initial posture selection control 43. The initial posture selection control 43 is switched from the display status to the hiding status in response to a hiding operation on the initial posture selection control.

Illustratively, as shown in FIG. 7, at least one preset posture option includes: a slightly blowing posture, a wishing posture, a first raising posture, an akimbo posture, a crossed arms posture, and the like.

Operation 233: Display, in response to a selection operation on a first posture option of the at least one preset posture option, an initial posture of a target model virtual character in a virtual environment to a first posture corresponding to the first posture option.

In some aspects, the first posture option correspondingly stores posture data corresponding to the first posture. The posture data corresponding to the first posture is imported into a skeleton model of the target model virtual character, so as to set the initial posture of the target model virtual character in the virtual environment to the first posture corresponding to the first posture option.

Operation 235: Display, in response to a selection operation on a second posture option of the at least one generated posture option, an initial posture of a target model virtual character in a virtual environment to a second posture corresponding to the second posture option.

In some aspects, the second posture option correspondingly stores posture data corresponding to the second posture. The posture data corresponding to the second posture is imported into a skeleton model of the target model virtual character, so as to set an initial posture of the target model virtual character in the virtual environment to the second posture corresponding to the second posture option.

In some aspects, during posture editing, the user may still modify the initial posture of the target model virtual character. During switching to a next initial posture, if an initial posture before switching is already edited, switching to the next initial posture requires re-confirmation.

In conclusion, according to the method provided in this aspect, at least one preset posture option preset in a system is provided, so that a user can use several basic preset postures as a start point for creating a customized posture, thereby reducing a large number of operations during posture editing. For an electronic device with limited operation manners, such as a mobile phone or a tablet computer, human computer operation costs of a user can be reduced, and a more personalized customized posture can be created more easily with fewer human computer operations.

According to the method provided in this aspect, at least one generated posture option created by a current user and/or another user is further provided, so that the current user can use, as a start point for recreation, a customized posture generated by another user, and can add creativity based on creativity of another user, thereby facilitating generation of a customized posture combining creativity of different users.

### 4. Formation Editing Function

FIG. 15 is a schematic diagram of formation editing according to an illustrative aspect described herein. As shown in FIG. 15, a formation editing control 55 and a circular region control 56 are displayed in a group posture editing interface 20.

In response to a trigger operation on the formation editing control 55, a circular region may be added in a virtual environment. One circular region is displayed in a one-to-one correspondence with one model virtual character. Referring to FIG. 15, a model virtual character 2211 is displayed in correspondence with a circular region 2212, a model virtual character 2213 is displayed in correspondence with a circular region 2214, and a model virtual character 2215 is displayed in correspondence with a circular region 2216.

In some aspects, the formation editing control 55 displays at least one of the following: a number of circular regions that have been placed in a current formation, a total number of circular regions that can be placed in the current formation, and a remaining number of circular regions that can be placed in the current formation.

In response to a selection operation on the circular region control 56, a selected circular region may be deleted from the virtual environment.

In some aspects, to distinguish circular regions corresponding to different virtual characters in the current formation, all the circular regions are in a one-to-one correspondence with numerical marks.

In some aspects, as shown in FIG. 15, the circular region control 56 includes four circular region controls with numerical marks 1 to 4.

In response to a circular region adding operation, a circular region control with a numerical mark 5 is added at the tail of a circular region queue of a current formation. In some aspects, an initial posture of a model virtual character corresponding to the circular region control with the numerical mark 5 is set. In some aspects, the newly added circular region control is not a circular region control that is selected by default.

In response to a selection operation on the circular region control 56, assuming that a numerical mark of a currently selected circular region control is 3, the circular region control with the numerical mark 3 is deleted from the virtual environment. In some aspects, a numerical mark of a remaining circular region control in the virtual environment does not change.

In response to a circular region adding operation, the circular region control with the numerical mark 3 is added in a circular region queue of a current formation. In some aspects, an initial posture of a model virtual character corresponding to the circular region control with the numerical mark 3 is set. In some aspects, the newly added circular region control is not a circular region control that is selected by default.

In some aspects, the numerical mark of the newly added circular region control is the smallest numerical mark of numerical marks corresponding to empty circular regions in the current formation. Illustratively, the numerical marks corresponding to the empty circular regions in the current formation are 3, 6, and 9. Therefore, when adding circular region controls, a numerical mark of a circular region control that is added first is set to 3, a numerical mark of a circular region control that is then added is set to 6, and a numerical mark of a circular region control that is added last is set to 9.

In some aspects, in the group posture editing interface 20, as a number of circular regions in the formation increases or decreases, a number of model virtual characters in the formation also correspondingly increases or decreases.

Illustratively, two circular region controls are displayed in the group gesture editing interface 20, and numerical marks are respectively 1 and 2. In response to a circular region adding operation, the circular region control with the numerical mark 3 is displayed in the group gesture editing interface 20, and a model virtual character corresponding to the circular region control with the numerical mark 3 is displayed at a central position of the virtual environment.

If the central position of the virtual environment cannot be used for placing the model virtual character, the model virtual character corresponding to the circular region control with the numerical mark 3 is displayed at the boundary of a region in which the model virtual character can be placed. The model virtual character corresponding to the circular region control with the numerical mark 3 is in an initial posture.

If a plurality of model virtual characters are added at the same time in the same position in the virtual environment, the plurality of model virtual characters are displayed at an interval of a particular distance.

In some aspects, a formation locking control is displayed in the group posture editing interface 20, configured to lock a specified formation. The locked formation displays a locking mark in a menu bar in the initial formation selection control 53.

In some aspects, the locked formation may be subject to at least one of the following operations: a formation selection operation and an unlocking operation. In some aspects, another operation such as an editing operation cannot be performed on the locked formation.

In some aspects, a body position editing control is displayed in the group posture editing interface 20, as shown in FIG. 16. For example, the body position editing control is in a form of floating joystick 54. In response to a dragging operation on the floating joystick 54 in at least one of upward, downward, leftward, and rightward directions, the target model virtual character is controlled to move in a corresponding direction in the virtual environment. In some aspects, the target model virtual character moves at a fixed speed in a space range indicated by the ground grid.

In some aspects, a body orientation editing control is displayed in the group posture editing interface 20, as shown in FIG. 16. For example, the body orientation editing control is in a form of rotation joystick 57. In response to a dragging operation on the rotation joystick 57 in at least one of upward, downward, leftward, and rightward directions, the target model virtual character is controlled to rotate in a corresponding direction in the virtual environment, so that the body of the target model virtual character orients towards the corresponding direction in the virtual environment. In some aspects, the target model virtual character rotates at a fixed speed in a space range indicated by the ground grid.

In some aspects, a rotation angle of the target model virtual character is determined based on the dragging operation on the rotation joystick 57, a current orientation of the target model virtual character is used as a rotation base point, and the target model virtual character is rotated by the determined rotation angle relative to the rotation base point, so that the body orientation of the target model virtual character correspondingly changes.

In some aspects, the body position editing control and the body orientation editing control may be implemented as the same control or different controls.

### 5. Posture Editing Function

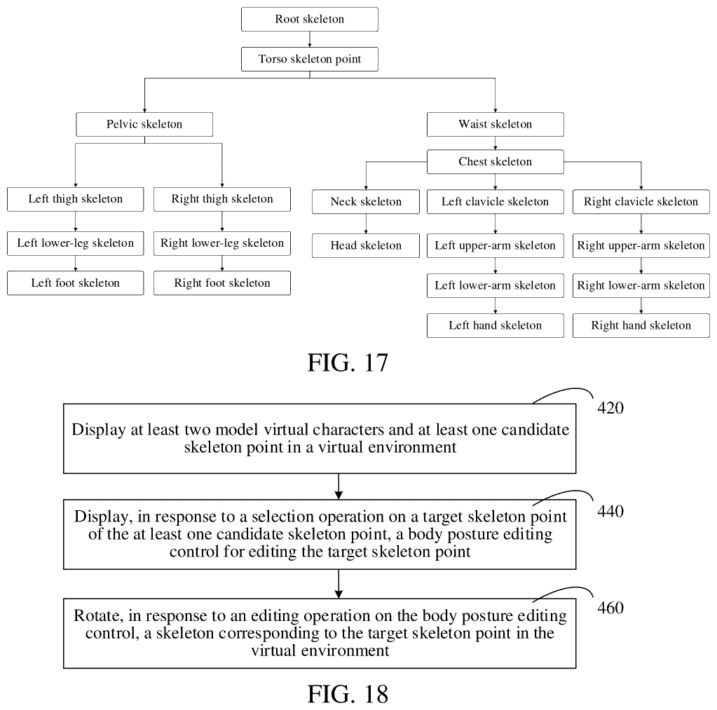

FIG. 17 is a schematic diagram of a skeleton model of a virtual character according to an illustrative aspect described herein. The skeleton model includes a plurality of skeleton chains. Each skeleton chain includes at least one skeleton, and a joint is further formed between adjacent skeletons.

Illustratively, the plurality of skeleton chains include:
a head skeleton chain, including: a head skeleton and a neck skeleton.
an upper-body skeleton chain, including: a chest skeleton, a waist skeleton, a left-hand skeleton chain, and a right-hand skeleton chain, where the left-hand skeleton chain includes: a left clavicle skeleton, a left upper-arm skeleton, a left lower-arm skeleton, and a left-hand skeleton, and the right-hand skeleton chain includes: a right clavicle skeleton, a right upper-arm skeleton, a right lower-arm skeleton, and a right-hand skeleton.
a lower-body skeleton chain, including: a pelvic skeleton, a left-leg skeleton chain, and a right-leg skeleton chain, where the left-leg skeleton chain includes: a left thigh skeleton, a left lower-leg skeleton, and a left foot skeleton, and the right-leg skeleton chain includes: a right thigh skeleton, a right lower-leg skeleton, and a right foot skeleton.

A representative joint or skeleton in the skeleton model is set as an editable skeleton point. For example, the editable skeleton point includes: a head skeleton point, a neck skeleton point, a chest skeleton point, a waist skeleton point, a left shoulder skeleton point, a left elbow skeleton point, a left hand skeleton point, a right shoulder skeleton point, a right elbow skeleton point, a right hand skeleton point, a left crotch skeleton point, a left knee skeleton point, a left foot skeleton point, a right crotch skeleton point, a right knee skeleton point, and a right foot skeleton point.

In some aspects, in response to a selection operation on a target circular region in the group posture editing interface 20, a mode selection button for editing a target model virtual character in the target circular region is displayed.

Illustratively, at least one of the following mode selection buttons is displayed in the group posture editing interface: a joint mode, an orientation mode, a gesture mode, and an expression mode. The joint mode includes: a convenient editing mode and an expert editing mode.

In response to a selection operation on the joint mode, an editing control related to posture editing of a skeleton point is displayed. Further, in response to a selection operation on the convenient editing mode, postures of a skeleton point and at least two skeletons corresponding to the skeleton point on a skeleton chain are edited based on an IK mode. In response to a selection operation on the expert editing mode, a posture of a single skeleton corresponding to the skeleton point is edited.

### 1. Content Related to Expert Editing Mode.

FIG. 18 is a flowchart of a virtual character posture editing method according to an illustrative aspect described herein. In this aspect, for example, the method is performed by a terminal. The method includes:

Operation 420: Display at least two model virtual characters and at least one candidate skeleton point in a virtual environment.

The at least two model virtual characters and the at least one candidate skeleton point in the virtual environment are displayed in the group posture editing interface.

Illustratively, the at least one candidate skeleton point includes: a head skeleton point, a neck skeleton point, a back skeleton point, a waist skeleton point, a left shoulder skeleton point, a left elbow skeleton point, a left hand skeleton point, a right shoulder skeleton point, a right elbow skeleton point, a right hand skeleton point, a left crotch skeleton point, a left knee skeleton point, a left foot skeleton point, a right crotch skeleton point, a right knee skeleton point, and a right foot skeleton point.

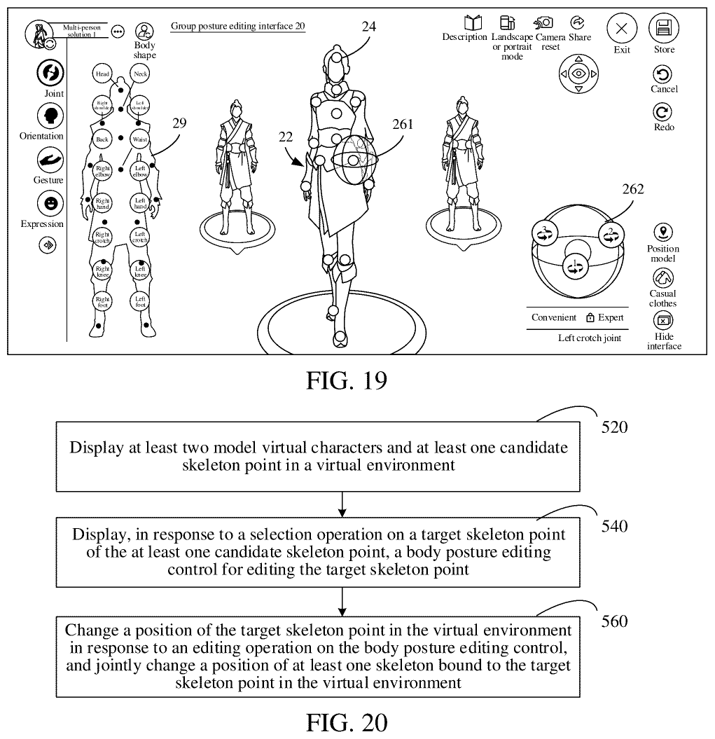

In some aspects, referring to FIG. 19, the group gesture editing interface 20 includes a schematic diagram 29 of skeleton points displayed by using an HUD control and an option control of at least one candidate skeleton point connected to a related part on the schematic diagram of skeleton points by using a lead. The schematic diagram 29 of skeleton points is a two-dimensional schematic diagram independent of a target model virtual character 22. Names of current candidate skeleton points are displayed on option controls of the skeleton points.

In some aspects, referring to FIG. 19, the group posture editing interface 20 includes at least one candidate skeleton point 24 attached to a skeleton model of the target model virtual character 22. These candidate skeleton points 24 are displayed in corresponding positions of the skeleton model of the target model virtual character 22 through dotted controls.

Operation 440: Display, in response to a selection operation on a target skeleton point of the at least one candidate skeleton point, a body posture editing control for editing the target skeleton point.

The selection operation is at least one of a click operation, a double-click operation, a press operation, a slide operation, a voice control operation, and an eye control operation.

In some aspects, the body posture editing control for editing the target skeleton point is displayed in response to the selection operation on the target skeleton point of the at least one candidate skeleton point in the schematic diagram of skeleton points. In some aspects, the body posture editing control for editing the target skeleton point is displayed in response to the selection operation on the target skeleton point of the at least one candidate skeleton point of the model virtual character.

Illustratively, referring to FIG. 19, the editing control corresponding to the target skeleton point includes: a rotation control 1, a rotation control 2, and a rotation control 3 that respectively correspond to the three coordinate axes. The rotation control 1 is configured to perform rotation control around the x-axis, the rotation control 2 is configured to perform rotation control around the y-axis, and the rotation control 3 is configured to perform rotation control around the z-axis.

Operation 460: Rotate, in response to an editing operation on the body posture editing control, a skeleton corresponding to the target skeleton point in the virtual environment. The operation includes at least some of the following operations:
rotating, around the x-axis in response to a first editing operation on the body posture editing control, the skeleton corresponding to the target skeleton point in the virtual environment;
rotating, around the y-axis in response to a second editing operation on the body posture editing control, the skeleton corresponding to the target skeleton point in the virtual environment; and
rotating, around the z-axis in response to a third editing operation on the body posture editing control, the skeleton corresponding to the target skeleton point in the virtual environment.

Each skeleton point has a corresponding skeleton. When a skeleton point is not a joint, a skeleton corresponding to the skeleton point is a skeleton directly indicated by the skeleton point. When the skeleton point is a joint, a skeleton corresponding to the skeleton point is a next-level skeleton connected to the joint. At least two skeletons on the skeleton chain may be sequentially referred to as a first-level skeleton, a second-level skeleton, a third-level skeleton, and the like in a direction from a root skeleton to an end skeleton.

In some aspects, the skeletons corresponding to the target skeleton point include at least one of the following:

When the target skeleton point is a head skeleton point, skeletons corresponding to the head skeleton point are all head skeletons; when the target skeleton point is a neck skeleton point, skeletons corresponding to the neck skeleton point are all neck skeletons; when the target skeleton point is a back skeleton point, skeletons corresponding to the back skeleton point are skeletons between back and waist; when the target skeleton point is a waist skeleton point, skeletons corresponding to the waist skeleton point are skeletons between waist and crotch.

When the target skeleton point is a left shoulder skeleton point, skeletons corresponding to the left shoulder skeleton point are left upper arm skeletons; when the target skeleton point is a left elbow skeleton point, skeletons corresponding to the left elbow skeleton point are left lower arm skeletons; when the target skeleton point is a left hand skeleton point, skeletons corresponding to the left hand skeleton point are all left hand skeletons; when the target skeleton point is a right shoulder skeleton point, skeletons corresponding to the right shoulder skeleton point are right upper arm skeletons; when the target skeleton point is a right elbow skeleton point, skeletons corresponding to the right elbow skeleton point are right lower arm skeletons; when the target skeleton point is a right hand skeleton point, skeletons corresponding to the right hand skeleton point are all right hand skeletons.

When the target skeleton point is a left crotch skeleton point, skeletons corresponding to the left crotch skeleton point are left thigh skeletons; when the target skeleton point is a left knee skeleton point, skeletons corresponding to the left knee skeleton point are left lower leg skeletons; when the target skeleton point is a left foot skeleton point, skeletons corresponding to the left foot skeleton point are all left foot skeletons; when the target skeleton point is a right crotch skeleton point, skeletons corresponding to the right crotch skeleton point are right thigh skeletons; when the target skeleton point is a right knee skeleton point, skeletons corresponding to the right knee skeleton point are right lower leg skeletons; and when the target skeleton point is a right foot skeleton point, skeletons corresponding to the right foot skeleton point are all right foot skeletons.

When the target skeleton point is not a joint, the skeleton corresponding to the target skeleton point is rotated in the virtual environment by using a midpoint or a center of the skeleton corresponding to the target skeleton point as a rotation center. When the target skeleton point is a joint, the skeleton corresponding to the target skeleton point is rotated in the virtual environment by using the target skeleton point as a rotation center.

In conclusion, according to the method provided in this aspect, the body posture editing control of the target skeleton point is provided for a player, and the skeleton corresponding to the target skeleton point is rotated in the virtual environment in response to an editing operation on the body posture editing control, thereby precisely controlling the skeleton corresponding to the target skeleton point, and providing a refined posture editing solution for the player. The user may generate various customized postures through editing, and subsequently apply the generated customized posture to a virtual character controlled by a current user or another user.

### 2. Content Related to Convenient Editing Mode.

FIG. 20 is a schematic flowchart of a virtual character posture editing method according to an illustrative aspect described herein. In this aspect, for example, the method is performed by a terminal. The method includes:

Operation 520: Display at least two model virtual characters and at least one candidate skeleton point in a virtual environment.

The at least two model virtual characters and the at least one candidate skeleton point in the virtual environment are displayed in the group posture editing interface.

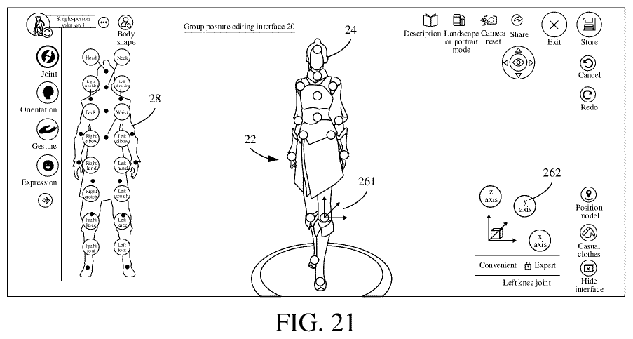

Illustratively, referring to FIG. 21, the group gesture editing interface 20 includes a schematic model 28 of skeleton points displayed by using an HUD control and an option control of at least one candidate skeleton point connected to a related part on the schematic model 28 of skeleton points by using a lead. The schematic model 28 of skeleton points is a two-dimensional schematic diagram independent of a model virtual character 22. Names of current candidate skeleton points are displayed on option controls of the skeleton points.

In some aspects, the group posture editing interface 20 further includes at least one candidate skeleton point 24 attached to a skeleton model of the model virtual character 22. These candidate skeleton points 24 are displayed in corresponding positions of the skeleton model of the model virtual character 22 through dotted controls.

Illustratively, the at least one candidate skeleton point 24 includes: a head skeleton point, a neck skeleton point, a back skeleton point, a waist skeleton point, a left shoulder skeleton point, a left elbow skeleton point, a left hand skeleton point, a right shoulder skeleton point, a right elbow skeleton point, a right hand skeleton point, a left crotch skeleton point, a left knee skeleton point, a left foot skeleton point, a right crotch skeleton point, a right knee skeleton point, and a right foot skeleton point.

Operation 540: Display, in response to a selection operation on a target skeleton point of the at least one candidate skeleton point, a body posture editing control for editing the target skeleton point.

The selection operation is at least one of a click operation, a double-click operation, a press operation, a slide operation, a voice control operation, and an eye control operation.

In some aspects, the body posture editing control for editing the target skeleton point is displayed in response to the selection operation on an option of the target skeleton point of the at least one candidate skeleton point in the schematic model 28 of skeleton points. In some aspects, the body posture editing control for editing the target skeleton point is displayed in response to the selection operation on the target skeleton point of the at least one candidate skeleton point 24 of the model virtual character 22.

Illustratively, referring to FIG. 21, in this aspect, the target skeleton point is a left knee skeleton point.

Operation 560: Change a position of the target skeleton point in the virtual environment in response to an editing operation on the body posture editing control, and jointly change a position of at least one skeleton bound to the target skeleton point in the virtual environment.

The skeleton model includes at least one skeleton chain. Each skeleton chain includes one root skeleton and at least one end skeleton. All or some skeleton chains further include an intermediate skeleton located between the root skeleton and the end skeleton. In different aspects, skeleton chains are classified in different manners. Illustratively, referring to FIG. 17, related content is not described herein again.

The position of the target skeleton point in the virtual environment is changed in response to an editing operation on the body posture editing control, and the position of at least one skeleton bound to the target skeleton point in the virtual environment is jointly changed. The at least one skeleton bound to the target skeleton point is usually a skeleton belonging to the same skeleton chain as the target skeleton point. In some aspects, the at least one skeleton bound to the target skeleton point includes all skeletons belonging to the same skeleton chain as the target skeleton point. In some aspects, the at least one skeleton bound to the target skeleton point includes some skeletons belonging to the same skeleton chain as the target skeleton point, for example, lower-level skeletons of the target skeleton point.

In some aspects, the user may change the position of the target skeleton point through direct dragging, to jointly change at least one skeleton belonging to the same skeleton chain as the target skeleton point. Because directly dragging the target skeleton point of the model virtual character is very intuitive and is similar to a manner of operating a “puppet”, a user can intuitively operate without any learning costs and can readily apply.

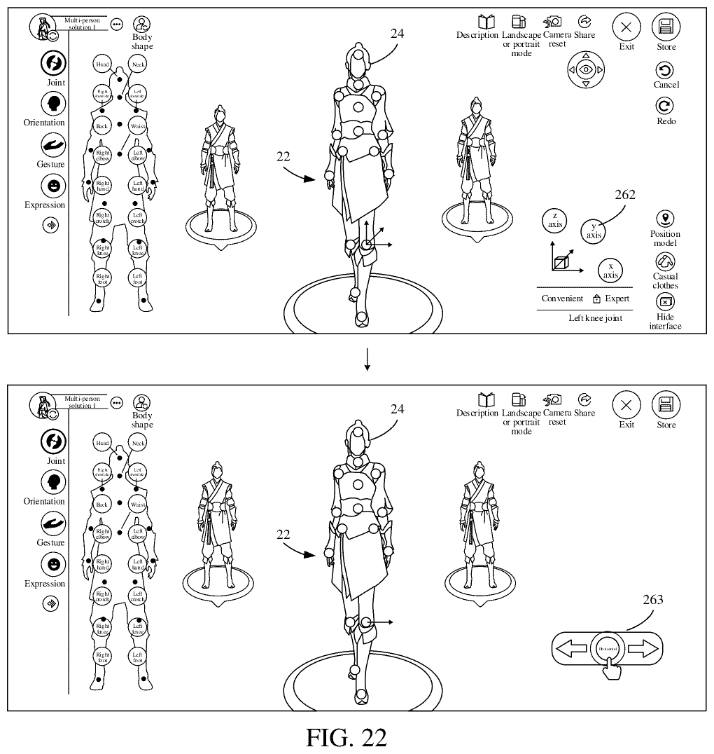

In some aspects, the user may change the position of the target skeleton point through a slide joystick, to jointly change at least one skeleton belonging to the same skeleton chain as the target skeleton point. Illustratively, as shown in FIG. 22, the editing control for editing the target skeleton point includes: second dragging controls 262 respectively corresponding to the three coordinate axes, where each second dragging control 262 is configured to implement dragging control corresponding to one of the three coordinate axes.

The virtual environment is constructed based on a world coordinate system. The three coordinate axes are three coordinate axes in the world coordinate system, and are three coordinate axes in a private coordinate system constructed by using the target skeleton point as an origin. Illustratively, the second dragging controls respectively corresponding to the three coordinate axes include: a second dragging control corresponding to the x-axis, a second dragging control corresponding to the y-axis, and a second dragging control corresponding to the z-axis.

Most target skeleton points can be dragged on the three coordinates axes. Due to limitation such as limb bending limit, a few target skeleton points can be dragged only on one or two coordinate axes. In this case, the second dragging control corresponding to a coordinate axis on which a skeleton point cannot be dragged is displayed in an unavailable status or hidden.

In some aspects, the second dragging controls 262 respectively corresponding to the three coordinate axes are implemented by using an HUD control, and are displayed in separation from the model virtual character.

In some aspects, when a touch operation on the second dragging control corresponding to the first coordinate axis is detected, display of the second dragging controls corresponding to the second coordinate axis and the third coordinate axis is canceled.

The touch operation is a touch down event detected on the second dragging control 262 corresponding to the first coordinate axis. For example, one click operation includes one touch down event and one touch up event. One sliding/dragging operation includes: one touch down event, at least one touch move event, and one touch up event. In some aspects, the touch down event is also referred to as a touch start event, and the touch up event is also referred to as a touch end event.

The second dragging control 262 corresponding to the first coordinate axis is a selected second dragging control of the three second dragging controls. The first coordinate axis is any one of the three coordinate axes. In this aspect, for example, the first coordinate axis is the x axis.

The second coordinate axis and the third coordinate axis are other two coordinate axes of the three coordinate axes other than the first coordinate axis.

Because a display area of the terminal is limited, to provide a larger operating area for the user, when the touch operation on the second dragging control corresponding to the first coordinate axis is detected, display of the second dragging controls corresponding to the second coordinate axis and the third coordinate axis is canceled.

In some aspects, when the touch operation on the second dragging control corresponding to the first coordinate axis is detected, the second dragging control corresponding to the first coordinate axis is switched from a button form to a slide joystick form.

In some aspects, the three second dragging controls 262 all have two display forms: a button form and a slide joystick form. The slide joystick form includes a slide slot and a joystick located on the slide slot. By default, the three second dragging controls are displayed in a button form. A display area of the second dragging control in a form of a single button is smaller than a display area in a form of a single circular wheel.

When the touch operation on the second dragging control 262 corresponding to the first coordinate axis is detected, the second dragging control 262 corresponding to the first coordinate axis is switched from a button form to a slide joystick form 263.

In some aspects, in response to a dragging operation on the second dragging control corresponding to the first coordinate axis, the skeleton corresponding to the target skeleton point is dragged around the first coordinate axis by using the target skeleton point as a dragging base point.

In some aspects, in response to an operation of dragging, in a first dragging direction, the second dragging control 262 corresponding to the first coordinate axis, the skeleton corresponding to the target skeleton point is dragged around the first coordinate axis in a clockwise direction by using the target skeleton point as a dragging base point. Alternatively, in response to an operation of dragging, in a second dragging direction, the second dragging control 262 corresponding to the first coordinate axis, the skeleton corresponding to the target skeleton point is dragged around the first coordinate axis in a counterclockwise direction by using the target skeleton point as a dragging base point. Alternatively, in response to an operation of dragging, in a first dragging direction, the second dragging control 262 corresponding to the first coordinate axis, the skeleton corresponding to the target skeleton point is dragged around the first coordinate axis in a clockwise direction by using the target skeleton point as a dragging base point, and in response to an operation of dragging, in a second dragging direction, the second dragging control 262 corresponding to the first coordinate axis, the skeleton corresponding to the target skeleton point is dragged around the first coordinate axis in a counterclockwise direction by using the target skeleton point as a dragging base point.

In some aspects, the position of at least one skeleton bound to the target skeleton point in the virtual environment is jointly changed based on the position of the target skeleton point in the virtual environment.

Illustratively, a model virtual character is displayed based on a skeleton model, and the skeleton model includes at least one skeleton chain.

Illustratively, this operation includes: using, as the at least one skeleton bound to the target skeleton point, at least one skeleton belonging to the same skeleton chain as the target skeleton point; and jointly changing, through IK based on the position of the target skeleton point in the virtual environment, the position of the at least one skeleton bound to the target skeleton point in the virtual environment.

In some aspects, at least one skeleton that belongs to the same skeleton chain as the target skeleton point and that is located at an upper level of the target skeleton point is used as the at least one skeleton bound to the target skeleton point. In some aspects, at least one skeleton that belongs to the same skeleton chain as the target skeleton point and that is located at a lower level of the target skeleton point is used as the at least one skeleton bound to the target skeleton point. In some aspects, all skeletons belonging to the same skeleton chain as the target skeleton point are used as the at least one skeleton bound to the target skeleton point.

In some aspects, when the skeleton corresponding to the target skeleton point is dragged to a restricted position, the skeleton corresponding to the target skeleton point is kept in the restricted position.

When the skeleton corresponding to the target skeleton point is dragged to the restricted position, if a dragging operation in the same dragging direction is continuously received, the skeleton corresponding to the target skeleton point is kept in the restricted position. In other words, when the skeleton corresponding to the target skeleton point is kept in the restricted position, the second dragging control no longer responds to an editing operation that is beyond the restricted position, but can still respond to an editing operation that is not beyond the restricted position.

The restricted position includes at least one of a first restricted position and a second restricted position.

The first restricted position is set based on a skeleton physiological angle limit of a model virtual character. For example, an angle at which arms of a human body are twisted backwards is limited, and an angle at which a head of a human body is inclined backwards is limited.

The second restricted position is set based on an editing degree of freedom limit. The editing degree of freedom may be set by a developer or a user. For example, after creating a customized posture, a user does not expect a waist design of the customized posture to be significantly changed, and therefore, may set an editing degree of freedom limit for the waist of the customized posture. Then, another user can slightly adjust the waist of the model virtual character only within the editing degree of freedom limit.

In some aspects, if a touch leaving operation on a first dragging control is detected, display of a second dragging control and a third dragging control is restored. In some aspects, if the touch leaving operation on the first dragging control is detected, the first dragging control is switched from the slide joystick form back to the button form.

In conclusion, according to the method provided in this aspect, the editing control of the target skeleton point is provided for a player, and the position of the target skeleton point in the virtual environment is changed in response to an editing operation on the body posture editing control, and the position of at least one skeleton bound to the target skeleton point in the virtual environment is jointly changed, thereby changing postures of a plurality of skeletons through one editing operation, and providing a convenient posture editing solution for the player. The user may generate various customized postures through editing, and subsequently apply the generated customized posture to a virtual character controlled by a current user or another user.

### 3. Content Related to Orientation Mode.

In some aspects, the body posture editing control includes an orientation reference object control, configured to edit an orientation of a partial body part of a target model virtual character. For example, the partial body part is the face part and the eye part. The editing mode includes two editing modes: adjustment of a face orientation and adjustment of an eye orientation.

In some aspects, an orientation reference object control of a specified body part of a target model virtual character is displayed, and the specified body part is a partial body part of the target model virtual character. An orientation of the specified body part of the target model virtual character is changed in response to a trigger operation on an orientation reference object.

### Face Orientation

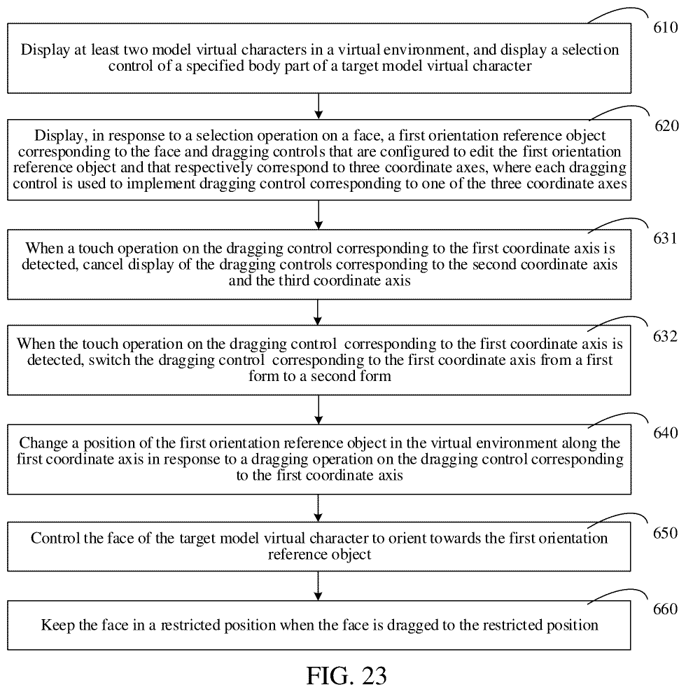

FIG. 23 is a flowchart of a body part orientation editing method according to an illustrative aspect described herein. In this aspect, for example, the method is performed by a terminal. The method includes:

Operation 610: Display at least two model virtual characters in a virtual environment, and display a selection control of a specified body part of a target model virtual character.

The at least two model virtual characters in the virtual environment are displayed in a group posture editing interface.

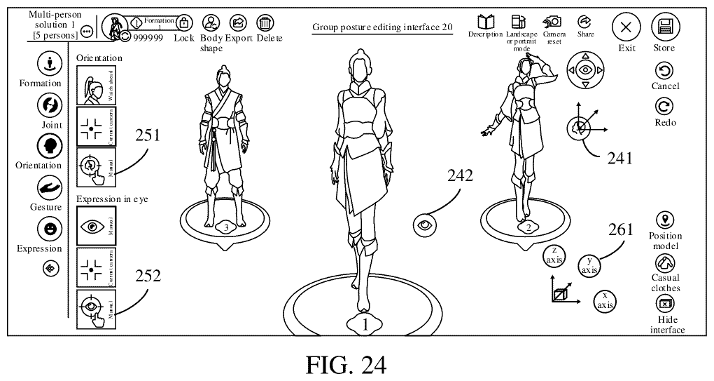

Illustratively referring to FIG. 24, a group posture editing interface 20 includes a menu item: a joint mode, an orientation mode, a gesture mode, and an expression mode.

In response to a selection operation on the orientation mode, a first manual editing control 251 related to a face orientation and a second manual editing control 252 related to an eye orientation are displayed. A manual adjustment function for the face orientation is triggered in response to a trigger operation on the first manual editing control 251. A manual adjustment function for the eye orientation is triggered in response to a trigger operation the second manual editing control 252.

Operation 620: Display, in response to a selection operation on a face, a first orientation reference object corresponding to the face and dragging controls that are configured to edit the first orientation reference object and that respectively correspond to three coordinate axes, where each dragging control is configured to implement dragging control corresponding to one of the three coordinate axes.

For example, the specified body part is a face part. Illustratively, referring to FIG. 24, a first orientation reference object 241 is displayed, and an editing control for editing the orientation reference object includes: dragging controls 261 respectively corresponding to the three coordinate axes, where each dragging control 261 is configured to implement dragging control corresponding to one of the three coordinate axes.

In some aspects, the dragging controls 261 respectively corresponding to the three coordinate axes are implemented by using an HUD control, and are displayed in separation from the model virtual character.

Operation 631: When a touch operation on the dragging control corresponding to the first coordinate axis is detected, cancel display of the dragging controls corresponding to the second coordinate axis and the third coordinate axis.

The touch operation is a touch down event detected on the dragging control 261 corresponding to the first coordinate axis.

The dragging control 261 corresponding to the first coordinate axis is a selected dragging control of the three dragging controls. The first coordinate axis is any one of the three coordinate axes. In this aspect, for example, the first coordinate axis is the x axis.

The second coordinate axis and the third coordinate axis are other two coordinate axes of the three coordinate axes other than the first coordinate axis.

Because a display area of the terminal is limited, to provide a larger operating area for the user, when the touch operation on the first dragging control is detected, display of the dragging controls corresponding to the second coordinate axis and the third coordinate axis is canceled.

Operation 632: When the touch operation on the dragging control corresponding to the first coordinate axis is detected, switch the dragging control corresponding to the first coordinate axis from a first form to a second form.

In some aspects, the three dragging controls 261 all have two display forms: a button form and a slide joystick form. The slide joystick form includes a slide slot and a joystick located on the slide slot. By default, the three dragging controls are displayed in a button form. A display area of the dragging control in a form of a single button is smaller than a display area in a form of a single circular wheel.

When the touch operation on the dragging control 261 corresponding to the first coordinate axis is detected, the dragging control 261 corresponding to the first coordinate axis is switched from a button form to a slide joystick form 262.

Operation 640: Change a position of the first orientation reference object in the virtual environment along the first coordinate axis in response to a dragging operation on the dragging control corresponding to the first coordinate axis.

The position of the orientation reference object in the virtual environment is changed along a positive semi-axis of the first coordinate axis in response to the dragging operation of dragging, to a first direction, the dragging control corresponding to the first coordinate axis. Alternatively, the position of the orientation reference object in the virtual environment is changed along a negative semi-axis of the first coordinate axis in response to the dragging operation of dragging, to a second direction, the dragging control corresponding to the first coordinate axis. Alternatively, the position of the orientation reference object in the virtual environment is changed along a positive semi-axis of the first coordinate axis in response to the dragging operation of dragging, to a first direction, the dragging control corresponding to the first coordinate axis; and the position of the orientation reference object in the virtual environment is changed along a negative semi-axis of the first coordinate axis in response to the dragging operation of dragging, to a second direction, the dragging control corresponding to the first coordinate axis.

Operation 650: Control the face part of the target model virtual character to orient towards the first orientation reference object.

Illustratively, the orientation of the face part of the target model virtual character is bound to a position of the first orientation reference object. When the position of the first orientation reference object in the virtual environment changes, the orientation of the face part of the target model virtual character is changed along with the position of the first orientation reference object.

In some aspects, a LookAT function is provided in a posture editor. Coordinates of the first orientation reference object in the virtual environment, coordinates of the face part of the target model virtual character, and an upward direction of the target model virtual character are used as parameters. A view matrix for transforming the face part of the target model virtual character may be returned by invoking the LookAT function. The face part of the target model virtual character is transformed based on the view matrix, so that the orientation of the face part of the target model virtual character may be changed along with the position of the first orientation reference object.

Operation 660: Keep the face in a restricted position when the face is dragged to the restricted position.

When the face is dragged to the restricted position, if a dragging operation in the same dragging direction is continuously received, the face is kept in the restricted position. In other words, when the face is kept in the restricted position, the dragging control no longer responds to an editing operation that is beyond the restricted position, but can still respond to an editing operation that is not beyond the restricted position.

The restricted position includes at least one of a first restricted position and a second restricted position.

The first restricted position is set based on a skeleton physiological angle limit of a model virtual character. For example, an angle at which arms of a human body are twisted backwards is limited, and an angle at which a head of a human body is inclined backwards is limited.

The second restricted position is set based on an editing degree of freedom limit. The editing degree of freedom may be set by a developer or a user. For example, after creating a customized posture, a user does not expect a waist design of the customized posture to be significantly changed, and therefore, may set an editing degree of freedom limit for the waist of the customized posture. Then, another user can slightly adjust the waist of the model virtual character only within the editing degree of freedom limit.

In conclusion, according to the method provided in this aspect, the editing control for the first orientation reference object is provided for a player, and the position of the first orientation reference object in the virtual environment is changed in response to an editing operation on the editing control. Then, the face part of the model virtual character is controlled to orient towards the first orientation reference object, thereby providing an orientation adjustment function for the face part of the virtual character and providing a convenient gesture editing solution for a player. The user may generate various customized postures through editing, and subsequently apply the generated customized posture to a virtual character controlled by a current user or another user.

According to the method provided in this aspect, the dragging controls respectively corresponding to the three coordinate axes are provided, so that a user may perform refined posture editing on the orientation reference object in three directions of the x-axis, the y-axis, and the z-axis. Through a plurality of times of posture editing, the user can edit a body part of a model virtual character to various expected postures. This provides refined posture editing.

According to the method provided in this aspect, when the dragging control corresponding to the first coordinate axis is selected, display of the dragging controls corresponding to the second coordinate axis and the third coordinate axis is cancelled, so that a number of controls displayed on the gesture editing interface can be reduced, and information interference to the user can be reduced while providing larger operation space for the user.

### Eye Orientation

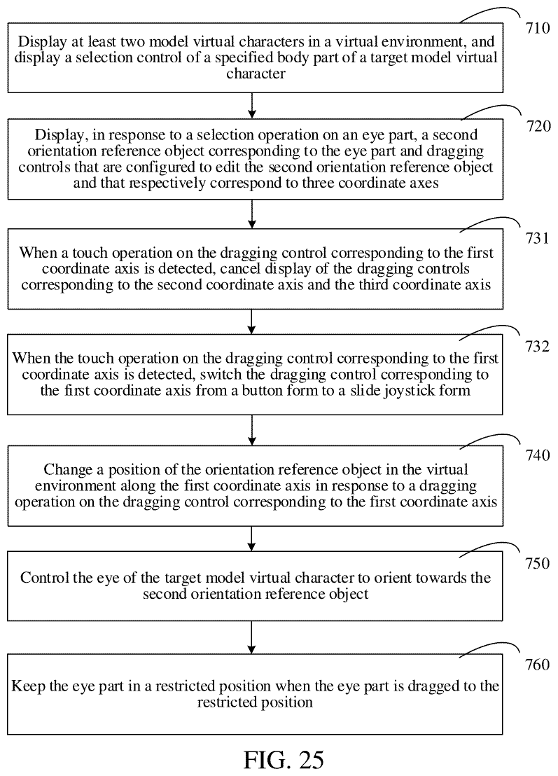

FIG. 25 is a flowchart of a body part orientation editing method according to an illustrative aspect described herein. In this aspect, for example, the method is performed by a terminal. The method includes:

Operation 710: Display at least two model virtual characters in a virtual environment, and display a selection control of a specified body part of a target model virtual character.

The at least two model virtual characters in the virtual environment are displayed in a group posture editing interface.

Illustratively referring to FIG. 24, a group posture editing interface 20 includes a menu item: a joint mode, an orientation mode, a gesture mode, and an expression mode.

In response to a selection operation on the orientation mode, a first manual editing control 251 related to a face orientation and a second manual editing control 252 related to an eye orientation are displayed. A manual adjustment function for the face orientation is triggered in response to a trigger operation on the first manual editing control 251. A manual adjustment function for the eye orientation is triggered in response to a trigger operation the second manual editing control 252.

Operation 720: Display, in response to a selection operation on an eye part, a second orientation reference object corresponding to the eye part and dragging controls that are configured to edit the second orientation reference object and that respectively correspond to three coordinate axes, where each dragging control is configured to implement dragging control corresponding to one of the three coordinate axes.

For example, the specified body part is an eye part. Illustratively, referring to FIG. 24, a second orientation reference object 242 is displayed, and an editing control for editing the orientation reference object includes: dragging controls 261 respectively corresponding to the three coordinate axes, where each dragging control 261 is configured to implement dragging control corresponding to one of the three coordinate axes.

In some aspects, the dragging controls 261 respectively corresponding to the three coordinate axes are implemented by using an HUD control, and are displayed in separation from the model virtual character.

In some aspects, the first orientation reference object 241 and the second orientation reference object 242 may be displayed simultaneously, and only one of the reference objects is currently activated. In some aspects, only one of the first orientation reference object 241 and the second orientation reference object 242 is displayed at a same time. When one orientation reference object is activated, the other orientation reference object is not displayed or is hidden.

Operation 731: When a touch operation on the dragging control corresponding to the first coordinate axis is detected, cancel display of the dragging controls corresponding to the second coordinate axis and the third coordinate axis.

The touch operation is a touch down event detected on the dragging control 261 corresponding to the first coordinate axis.

The dragging control 261 corresponding to the first coordinate axis is a selected dragging control of the three dragging controls. The first coordinate axis is any one of the three coordinate axes. In this aspect, for example, the first coordinate axis is the x axis.

The second coordinate axis and the third coordinate axis are other two coordinate axes of the three coordinate axes other than the first coordinate axis.

Because a display area of the terminal is limited, to provide a larger operating area for the user, when the touch operation on the first dragging control is detected, display of the dragging controls corresponding to the second coordinate axis and the third coordinate axis is canceled.

Operation 732: When the touch operation on the dragging control corresponding to the first coordinate axis is detected, switch the dragging control corresponding to the first coordinate axis from a button form to a slide joystick form.

In some aspects, the three dragging controls 261 all have two display forms: a button form and a slide joystick form. The slide joystick form includes a slide slot and a joystick located on the slide slot. By default, the three dragging controls are displayed in a button form. A display area of the dragging control in a form of a single button is smaller than a display area in a form of a single circular wheel.

When the touch operation on the dragging control 261 corresponding to the first coordinate axis is detected, the dragging control 261 corresponding to the first coordinate axis is switched from a button form to a slide joystick form 262.

Operation 740: Change a position of the second orientation reference object in the virtual environment along the first coordinate axis in response to a dragging operation on the dragging control corresponding to the first coordinate axis.

The position of the orientation reference object in the virtual environment is changed along a positive semi-axis of the first coordinate axis in response to the dragging operation of dragging, to a first direction, the dragging control corresponding to the first coordinate axis. Alternatively, the position of the second orientation reference object in the virtual environment is changed along a negative semi-axis of the first coordinate axis in response to the dragging operation of dragging, to a second direction, the dragging control corresponding to the first coordinate axis. Alternatively, the position of the orientation reference object in the virtual environment is changed along a positive semi-axis of the first coordinate axis in response to the dragging operation of dragging, to a first direction, the dragging control corresponding to the first coordinate axis; and the position of the second orientation reference object in the virtual environment is changed along a negative semi-axis of the first coordinate axis in response to the dragging operation of dragging, to a second direction, the dragging control corresponding to the first coordinate axis.

Operation 750: Control the eye part of the target model virtual character to orient towards the second orientation reference object.

Illustratively, the orientation of the eye part of the target model virtual character is bound to a position of the second orientation reference object. When the position of the second orientation reference object in the virtual environment changes, the orientation of the eye part of the target model virtual character is changed along with the position of the second orientation reference object.

In some aspects, a LookAT function is provided in a posture editor. Coordinates of the second orientation reference object in the virtual environment, coordinates of the eye part of the target model virtual character, and an upward direction of the target model virtual character are used as parameters. A view matrix for transforming the eye part of the target model virtual character may be returned by invoking the LookAT function. The eye part of the target model virtual character is transformed based on the view matrix, so that the orientation of the eye part of the target model virtual character may be changed along with the position of the second orientation reference object.

Operation 760: Keep the eye part in a restricted position when the eye part is dragged to the restricted position.

When the eye part is dragged to the restricted position, if a dragging operation in the same dragging direction is continuously received, the eye part is kept in the restricted position. In other words, when the eye part is kept in the restricted position, the dragging control no longer responds to an editing operation that is beyond the restricted position, but can still respond to an editing operation that is not beyond the restricted position.

The restricted position includes at least one of a first restricted position and a second restricted position.

The first restricted position is set based on a skeleton physiological angle limit of a model virtual character. For example, an angle at which arms of a human body are twisted backwards is limited, and an angle at which a head of a human body is inclined backwards is limited.

The second restricted position is set based on an editing degree of freedom limit. The editing degree of freedom may be set by a developer or a user. For example, after creating a customized posture, a user does not expect a waist design of the customized posture to be significantly changed, and therefore, may set an editing degree of freedom limit for the waist of the customized posture. Then, another user can slightly adjust the waist of the model virtual character only within the editing degree of freedom limit.

In conclusion, according to the method provided in this aspect, the editing control for the second orientation reference object is provided for a player, and the position of the second orientation reference object in the virtual environment is changed in response to an editing operation on the editing control. Then, the eye part of the target model virtual character is controlled to orient towards the second orientation reference object, thereby providing an orientation adjustment function for the eye part of the virtual character and providing a convenient gesture editing solution for a player. The user may generate various customized postures through editing, and subsequently apply the generated customized posture to a virtual character controlled by a current user or another user.

According to the method provided in this aspect, the dragging controls respectively corresponding to the three coordinate axes are provided, so that a user may perform refined posture editing on the orientation reference object in three directions of the x-axis, the y-axis, and the z-axis. Through a plurality of times of posture editing, the user can edit a body part of the target model virtual character to various expected postures. This provides refined posture editing.

According to the method provided in this aspect, when the dragging control corresponding to the first coordinate axis is selected, display of the dragging controls corresponding to the second coordinate axis and the third coordinate axis is cancelled, so that a number of controls displayed on the gesture editing interface can be reduced, and information interference to the user can be reduced while providing larger operation space for the user.

In some aspects, the body posture editing control includes a part orientation controlling control, configured to control an orientation of a partial body part of the target model virtual character. For example, the partial body part is the face part and the eye part. The editing mode includes two editing modes: control of a face orientation and control of an eye orientation.

In some aspects, a part orientation controlling control of a specified body part of the target model virtual character is displayed, and the specified body part is a partial body part of the target model virtual character. In response to a trigger operation on part orientation control, the specified body part is controlled to orient towards a position indicated by the controlling control in the virtual environment.

### Control of Face Orientation

Part orientation controlling controls related to a face orientation are displayed in the group gesture editing interface 20: a first front viewing control, a first camera viewing control, and a first camera following control.

The face part of the target model virtual character is controlled to orient towards right the front of the body of the target model virtual character in response to that a user clicks on the first front viewing control. The face part of the target model virtual character is controlled to orient towards the center of the group posture editing interface 20 in response to that a user clicks on the first camera viewing control. The face part of the target model virtual character is controlled to keep orienting towards the center of the group posture editing interface 20 in response to that a user clicks on the first camera following control.

### Control of Eye Orientation

Part orientation controlling controls related to an eye orientation are displayed in the group gesture editing interface 20: a second front viewing control, a second camera viewing control, and a second camera following control.

The eye part of the target model virtual character is controlled to orient towards right the front of the body of the target model virtual character in response to that a user clicks on the second front viewing control. The eye part of the target model virtual character is controlled to orient towards the center of the group posture editing interface 20 in response to that a user clicks on the second camera viewing control. The eye part of the target model virtual character is controlled to keep orienting towards the center of the group posture editing interface 20 in response to that a user clicks on the second camera following control.

In conclusion, according to the method provided in this aspect, the part orientation controlling control for a specified body part is provided for a player, and in response to a trigger operation on the part orientation controlling control, a specified body part of a model virtual character is controlled to orient towards a position indicated by the part orientation controlling control in the virtual environment, thereby providing a part orientation adjustment function for the specified body part of the virtual character, and providing a convenient gesture editing solution for the player. The user may generate various customized postures through editing, and subsequently apply the generated customized posture to a virtual character controlled by a current user or another user. Therefore, a UGC generation, application, and sharing solution for a virtual character posture is implemented.

### 4. Content Related to Gesture Mode.

In some aspects, the body posture editing control includes a part posture control, configured to control a posture of a partial body part of a target model virtual character. For example, the partial body part is the hand part and the face part. The editing mode includes two editing modes: adjustment of the hand part and adjustment of the face part.

In some aspects, at least one candidate posture of a specified body part of a target model virtual character is displayed in response to a trigger operation on the part posture control, where the candidate posture is used for presenting the specified body part in a preset posture. In response to a selection operation on a target posture of the at least one candidate posture, the specified body part is switched to a posture corresponding to the target posture.

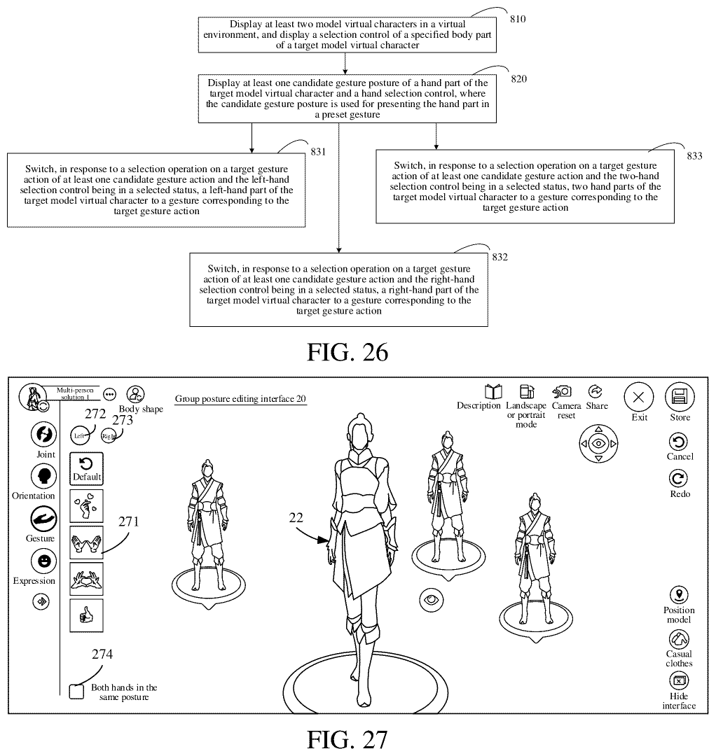

FIG. 26 is a flowchart of a complex part posture editing method according to an illustrative aspect described herein. In this aspect, for example, the method is performed by a terminal. The method includes:

Operation 810: Display at least two model virtual characters in a virtual environment, and display a selection control of a specified body part of a target model virtual character.

The at least two model virtual characters in the virtual environment are displayed in a group posture editing interface. The target model virtual character is displayed based on the skeleton model. The target model virtual character includes a hand part.

Operation 820: Display at least one candidate gesture posture of a hand part of the target model virtual character and a hand selection control, where the candidate gesture posture is used for presenting the hand part in a preset gesture.

Illustratively, referring to FIG. 27, one or more candidate gesture postures 271 of a hand part of a target model virtual character 22 are displayed in the group posture editing interface 20. Each candidate gesture posture 271 is used for presenting the hand part in a preset gesture posture. Different candidate gesture postures are different.

In some aspects, the candidate gesture posture 271 includes: at least one of a V-shaped victory gesture, a straight and closed gesture, a relaxing match gesture, a thumb-up gesture, a gesture of forming a heart shape, a relaxing waving gesture, an extended palm gesture, a clenched first gesture, and an unfolding gesture.

In some aspects, the hand selection control includes a left-hand selection control 272 and a right-hand selection control 273. In some aspects, the hand selection control includes a left-hand selection control 272, a right-hand selection control 273, and a two-hand selection control 274. The left-hand selection control 272 is configured to select a left-hand part. The right hand selection control 273 is configured to select a right-hand part. The two-hand selection control 274 is configured to select a left-hand part and a right-hand part at the same time.

Operation 831: Switch, in response to a selection operation on a target gesture action of at least one candidate gesture action and the left-hand selection control being in a selected status, a left-hand part of the target model virtual character to a gesture corresponding to the target gesture action.

In some aspects, local skeleton data corresponding to the left-hand part is pre-stored for each candidate gesture posture 271. If model virtual characters of a plurality of body shapes exist, local skeleton data of the candidate gesture posture 271 corresponding to the left-hand part is further stored for a model virtual character of each body shape.

In response to the selection operation on the target gesture action of the at least one candidate gesture action and the left-hand selection control being in the selected status, local skeleton data of the target gesture is queried based on a body shape of the target model virtual character, an ID of the target gesture posture, and a left-hand identifier. The local skeleton data of the left-hand part of the target model virtual character is replaced with the local skeleton data of the target gesture posture.

Operation 832: Switch, in response to a selection operation on a target gesture action of at least one candidate gesture action and the right-hand selection control being in a selected status, a right-hand part of the target model virtual character to a gesture corresponding to the target gesture action.

In some aspects, local skeleton data corresponding to the right-hand part is pre-stored for each candidate gesture posture 271. If model virtual characters of a plurality of body shapes exist, local skeleton data of the candidate gesture posture 271 corresponding to the right-hand part is further stored for a model virtual character of each body shape.

In response to the selection operation on the target gesture action of the at least one candidate gesture action and the right-hand selection control being in the selected status, local skeleton data of the target gesture is queried based on a body shape of the target model virtual character, an ID of the target gesture posture, and a right-hand identifier. The local skeleton data of the right-hand part of the target model virtual character is replaced with the local skeleton data of the target gesture posture.

Operation 833: Switch, in response to a selection operation on a target gesture action of at least one candidate gesture action and the two-hand selection control being in a selected status, two hand parts of the target model virtual character to a gesture corresponding to the target gesture action.

For the same target gesture action, the target gesture action of the left-hand part and the target gesture action of the right-hand part are symmetrical.

In conclusion, according to the method provided in this aspect, at least one candidate gesture posture of a hand part is provided for a player, and in response to a selection operation on a target gesture posture of the at least one candidate gesture posture, a hand part of a model virtual character is switched to a gesture posture corresponding to the target gesture posture, thereby changing an entire hand gesture posture through one editing operation, and providing a convenient gesture posture editing solution for a player. The user may generate various customized postures through editing, and subsequently apply the generated customized posture to a virtual character controlled by a current user or another user. Therefore, a UGC generation, application, and sharing solution for a virtual character gesture posture is implemented.

### 5. Content Related to Expression Mode.

In some aspects, the body posture editing control includes a part posture control, configured to control a posture of a partial body part of a target model virtual character. For example, the partial body part is the hand part and the face part. The editing mode includes two editing modes: adjustment of the hand part and adjustment of the face part.

In some aspects, at least one candidate posture of a specified body part of a target model virtual character is displayed in response to a trigger operation on the part posture control, where the candidate posture is used for presenting the specified body part in a preset posture. In response to a selection operation on a target posture of the at least one candidate posture, the specified body part is switched to a posture corresponding to the target posture.

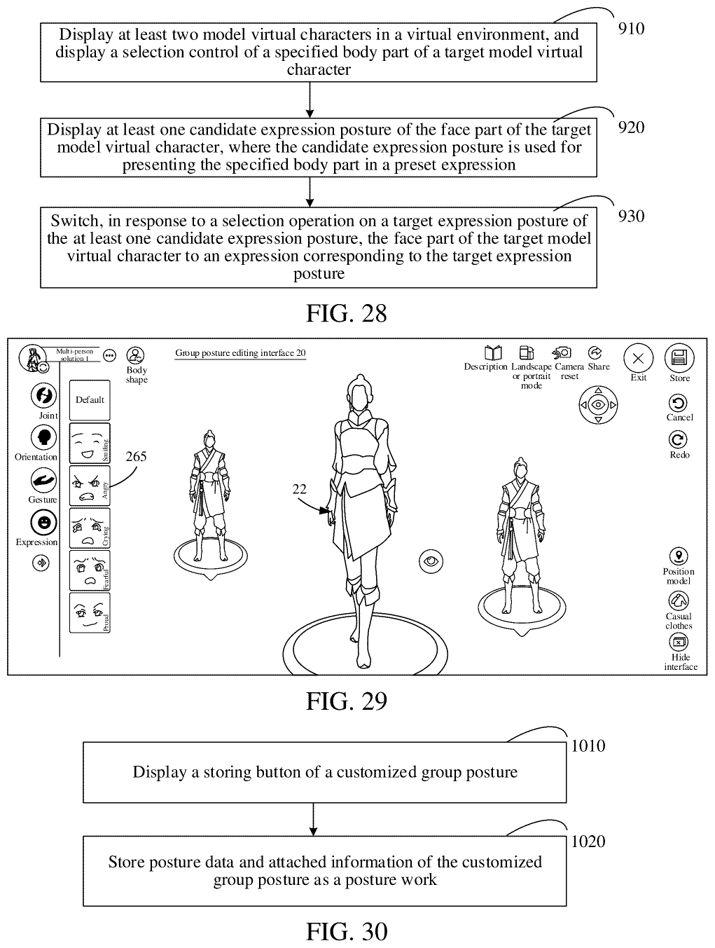

FIG. 28 is a flowchart of a complex part posture editing method according to an illustrative aspect described herein. In this aspect, for example, the method is performed by a terminal. The method includes:

Operation 910: Display at least two model virtual characters in a virtual environment, and display a selection control of a specified body part of a target model virtual character.

The at least two model virtual characters in the virtual environment are displayed in a group posture editing interface. The target model virtual character is displayed based on the skeleton model. The target model virtual character includes a plurality of body parts.

Illustratively, the target model virtual character includes: at least one body part of a head part, a torso part, a limb part, a hand part, a face part, and a foot part.

Some of the body parts include many skeletons, and it is inconvenient for a user to adjust the skeletons one by one. For example, the face part usually includes 36 skeletons, and it is difficult for a user to adjust the skeletons to desired expressions one by one.

In this aspect, the specified body part is a body part whose number of skeletons exceeds a preset threshold. The preset threshold may be 3, 5, or the like. The specified body part may also be specified in advance by an R&D engineer according to expert experience.

Operation 920: Display at least one candidate expression posture of the face part of the target model virtual character, where the candidate expression posture is used for presenting the specified body part in a preset expression.

Illustratively, referring to FIG. 29, one or more candidate expression postures 265 of a face part of a target model virtual character 22 are displayed in the group posture editing interface 20. Each candidate expression posture is used for presenting the face part in a preset expression posture. Different candidate expression postures are different.

In an illustrative example, the candidate expression posture includes: at least one of a smiling expression, a cool expression, a squinting smiling expression, a staring expression, an expression of closing two eyes, an expression of closing one eye, an angry expression, and a joyful smiling expression.

Operation 930: Switch, in response to a selection operation on a target expression posture of the at least one candidate expression posture, the face part of the target model virtual character to an expression corresponding to the target expression posture.

In some aspects, if model virtual characters of a plurality of body shapes exist, local skeleton data corresponding to the target expression posture is further stored for a model virtual character of each body shape.

In response to the selection operation on the target expression posture of the at least one candidate expression posture, local skeleton data of the target expression posture is queried based on a body shape of the target model virtual character and an ID of the target expression posture. The local skeleton data of the face part of the target model virtual character is replaced with the local skeleton data of the target expression posture. Therefore, the face part of the target model virtual character is switched to an expression corresponding to the target expression posture in the interface.

In conclusion, according to the method provided in this aspect, at least one candidate expression posture of a face part is provided for a player, and in response to a selection operation on a target expression posture of the at least one candidate expression posture, a face part of a model virtual character is switched to an expression posture corresponding to the target expression posture, thereby changing an entire face expression posture through one editing operation, and providing a convenient expression posture editing solution for a player. The user may generate various customized postures through editing, and subsequently apply the generated customized posture to a virtual character controlled by a current user or another user. Therefore, a UGC generation, application, and sharing solution for a virtual character expression posture is implemented.

Because a number of candidate postures of the same body part is limited, a personalized requirement of a user might not be completely satisfied. An aspect described herein further provides a candidate posture generation method. The method includes:
selecting, by a user, a first target posture and a second target posture from a plurality of preset candidate postures; where the first target posture is one of the plurality of candidate postures, the second target posture is another one of the plurality of candidate postures, and the first target posture and the second target posture are two different postures;
generating at least one intermediate posture by using the first target posture as a start posture and the second target posture as an end posture, where the at least one intermediate posture is a posture experienced in transition from the start posture to the end posture; and
switching, in response to a selection operation on the intermediate posture, a specified body part of a model virtual character to a posture corresponding to the intermediate posture, where the specified body part may be a hand part or a face part.

In some aspects, the generating at least one intermediate posture by using the first target posture as a start posture and the second target posture as an end posture includes:
obtaining first skeleton position data of the specified body part in the first target posture; obtaining second skeleton position data of the specified body part in the second target posture; and inputting the first skeleton position data, the second skeleton position data, and a desired number of postures to a neural network model, to obtain a desired number of intermediate postures.

The neural network model is trained as follows:

First sample skeleton position data of the specified body part in the first sample posture is obtained, where the first sample skeleton position data includes position information of each skeleton of the specified body part in the first sample posture. Second sample skeleton position data of the specified body part in the second sample posture is obtained, where the second sample skeleton position data includes position information of each skeleton of the specified body part in the second sample posture.

A number of sample intermediate postures is obtained, and a difference between position data of the same skeleton in the first sample skeleton position data and the second sample skeleton position data is obtained based on the number of sample intermediate postures, to obtain sample intermediate postures of the number of sample intermediate postures. That is, assuming that position information of the same skeleton in the first sample skeleton position data is (x1, y1, z1), position information in the second sample skeleton position data is (x2, y2, z2), and the number of sample intermediate postures is n, position information of an i^{th} sample intermediate posture is:
i/n*(x1, y1, z1)+ (n−i)/n*(x2, y2, z2), where i is an integer not greater than n.

The foregoing operations are repeated for each skeleton of the specified body part, to obtain third sample skeleton position data of each sample intermediate posture.

The neural network model is obtained through training based on the first sample skeleton position data, the second sample skeleton position data, and the number of sample intermediate postures as input data, and the third sample skeleton position data of the sample intermediate posture as label data. To enable the neural network model to be applicable to different numbers of intermediate postures, the number of sample intermediate postures may be set to a plurality of different values, to train the neural network model applicable to different numbers of intermediate postures.

In some aspects, the method further includes: capturing three-dimensional image data of a specified body part of a user by using a depth camera module; inputting the three-dimensional image data into the neural network model, to obtain skeleton position data of the specified body part corresponding to the three-dimensional image data; generating a posture of the specified body part of the virtual model character based on the skeleton position data of the specified body part; and switching the specified body part of the model virtual character to the posture.

The neural network model is obtained through training based on three-dimensional image data and skeleton position sub-data of model virtual characters in pairs. The three-dimensional image data of the virtual model character is obtained by capturing a specified body part of the virtual model character by using a camera model in a virtual environment when different skeleton positions are set. In this training manner, training samples of real human body parts are not needed, thereby greatly reducing difficulty in constructing a sample training set.

### 6. Store a Customized Posture

FIG. 30 is a flowchart of a customized posture storing method according to an illustrative aspect described herein. The method includes:

Operation 1010: Display a storing button of a customized posture.

There may be more than one position and timing for displaying the storing button.

Referring to FIG. 16, a storing button 61 is displayed in the group posture editing interface 20. In some aspects, when the group gesture editing interface is exited, a first pop-up window is displayed, and a storing button is displayed in the first pop-up window. In some aspects, when an initial group posture of a model virtual character is changed, a second pop-up window is displayed, and a storing button is displayed in the second pop-up window.

Operation 1020: Store posture data and attached information of the customized group posture as a posture work.

The posture data of the customized group posture is absolute group posture data or relative group posture data relative to the initial group posture. The absolute group posture data stores position information and rotation information of skeletons of at least two model virtual characters in the virtual environment. The relative group posture data stores posture offset values of skeletons of at least two model virtual characters relative to the initial group posture. In some aspects, the posture offset value includes at least one of a position offset value and a rotation offset value of each skeleton relative to the initial posture.

The posture data and attached information of the customized group posture are stored as a posture work of the customized group posture. The attached information includes: at least one piece of information of a unique identifier of the customized group posture, account information of a creator, a creation time, personalized information of at least two model virtual characters, body shape information of at least two model virtual characters, posture data of initial postures of at least two model virtual characters, a name of the customized group posture, and a preview image of the customized group posture.

In some aspects, the unique identifier of the customized group posture is generated by the terminal or the server.

In some aspects, in response to an operation of sharing the customized group gesture with a second account, sharing information of the customized group gesture is displayed in a network space whose access permission is possessed by the second account.

In some aspects, the first account and the second account have a friend relationship. In response to an operation of sharing the customized group posture to a chat window or a game mailbox corresponding to the second account, sharing information of the posture work corresponding to the customized posture is displayed in a chat window or a game mailbox whose access permission is possessed by the second account, so that the second account applies the customized group posture to a second virtual character.

In some aspects, the sharing information of the customized group gesture is displayed in a specified group in response to an operation of sharing the customized group gesture with the specified group.

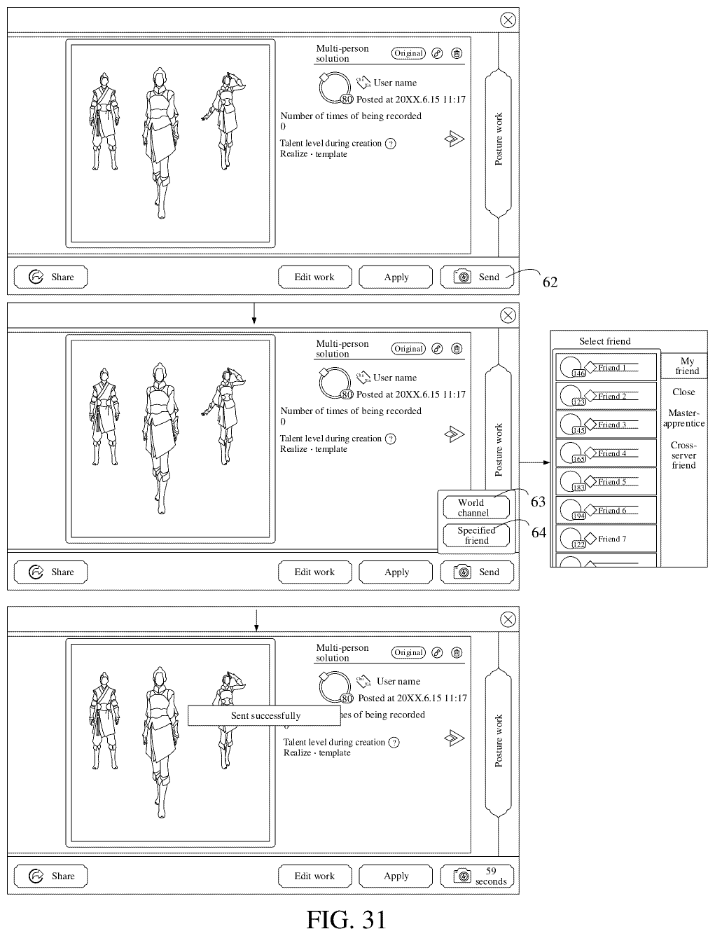

Illustratively, as shown in FIG. 31, a “send” button 62 is displayed in an introduction interface of a posture work. In response to a trigger operation on the “send” button 62, a world channel option 63 and a specified friend option 64 are displayed.

In response to a trigger operation on the specified friend option 64, a plurality of friends of the first account on a network are displayed, for example, a close friend, a friend with a master-apprentice relationship, and a cross-server friend. The customized group posture is shared with the second account in response to a trigger operation on the second account.

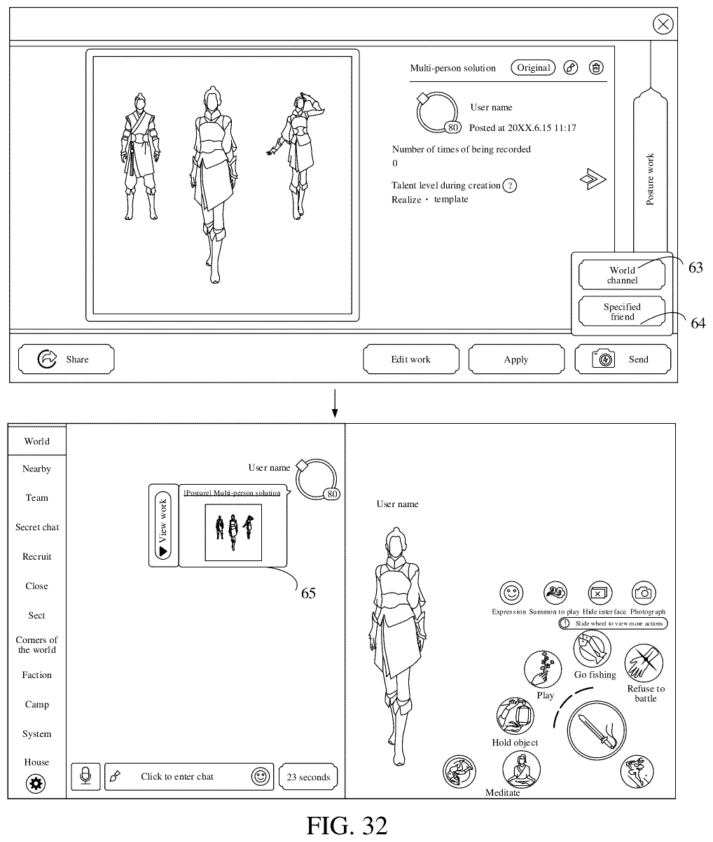

Illustratively, as shown in FIG. 31 and FIG. 32, in response to a trigger operation on the world channel option 63, the customized group gesture is shared in a chat box of the world channel, and is displayed as a shared message 65. Another account (for example, a third account) in the world channel views the preview image of the posture work by using the shared message 65.

In some aspects, information such as a name, a creator, a creation time, and a preview image of the posture work is displayed in the sharing information. Related data of the posture work is stored in a posture catalogue of the second account in response to a trigger operation on the sharing information.

In some aspects, a client in which the second/third account is logged into obtains absolute group posture data of the customized group posture, applies the absolute group posture data to the second virtual character, and displays the second virtual character in the customized group posture.

In some aspects, the client in which the second/third account is logged into obtains relative group posture data of the customized group posture, where the relative group posture data of the customized group posture is an offset value of the customized group posture relative to the initial group posture. The relative group posture data that is relative to the initial group posture and that corresponds to the customized group posture is obtained, and the relative group posture data of the customized group posture is superimposed with the posture data of the initial group posture, to obtain the absolute group posture data of the customized group posture. The absolute group posture data is applied to the second virtual character, and the second virtual character in the customized group posture is displayed.

The second account includes one or more accounts, and correspondingly, the second virtual character includes one or more virtual characters.

The third account includes one or more accounts, and correspondingly, the third virtual character includes one or more virtual characters.

In conclusion, according to the method provided in this aspect, posture data and attached information of the customized group posture are stored as a posture work, and the posture work is stored as a type of UGC. Therefore, it is convenient to share and apply the customized posture between different accounts.

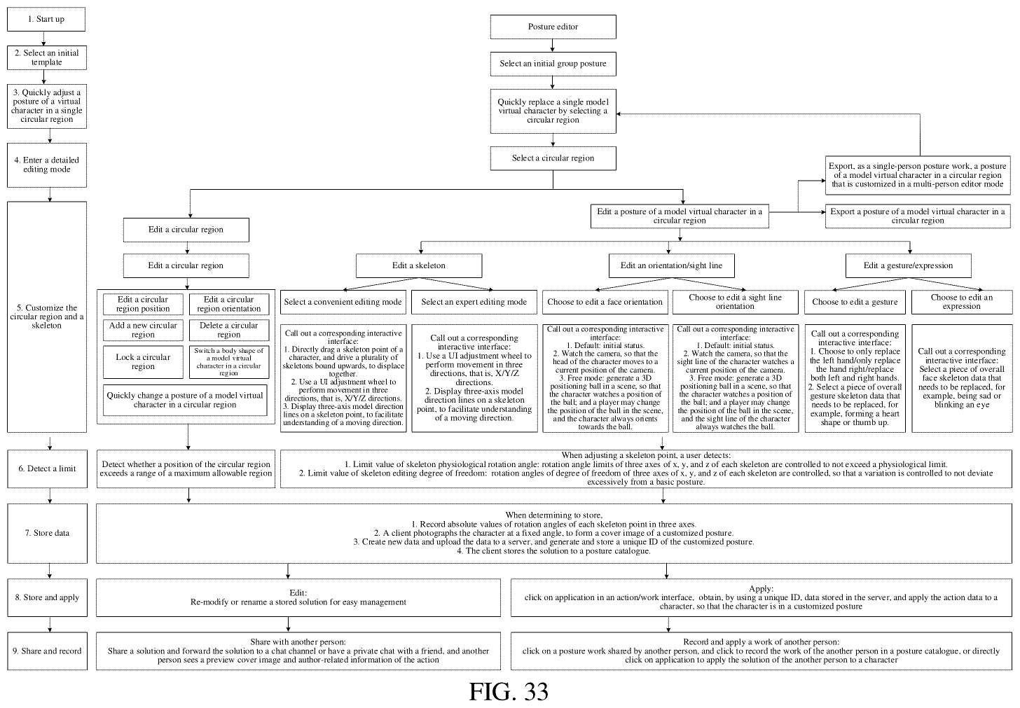

FIG. 33 is a flowchart of a virtual character posture editing method according to an illustrative aspect described herein. The method is performed by a terminal, and a client in which a first account is logged into runs in the terminal. The method includes:

### 1. Start Up

A user may open a posture editor through an entrance of the posture editor in the client.

In some aspects, the posture editor may be opened through a main interface to menu to entertainment home to posture catalogue to create a new multi-person work. After the user re-confirms, a virtual character controlled by the user is teleported to an independent virtual environment to enter a posture system. The independent virtual environment may be considered as a plane dedicated to postures.

### 2. Select an Initial Template.

After entering the posture system, a plurality of preset group postures are provided, and several different postures are automatically configured for the posture system. In this case, the user may select one preset group posture as an initial group posture. The initial group posture is alternatively referred to as an initial template.

### 3. Quickly Adjust a Posture of a Virtual Character in a Single Circular Region.

After a circular region is selected, a posture of a single model virtual character in the circular region may be quickly replaced.

### 4. Enter a Detailed Editing Mode.

After a circular region is selected, a detailed editing mode of the circular region may be entered.

### 5. Customize the Circular Region and a Skeleton.

After a circular region editing mode is entered, at least one of the following editing operations may be performed: editing a position of the circular region, editing an orientation of the circular region, adding a new circular region, deleting a circular region, locking a circular region, unlocking a circular region, switching a body shape of a model virtual character in a circular region, and quickly changing a posture of a model virtual character in a circular region.

After a skeleton editing mode is entered, a joint mode may be entered by default or selected, to display skeleton points of the character. The user may replace a partial skeleton in the posture by selecting a skeleton point that needs to be edited. The user may select a convenient editing mode to perform editing, or may select an expert editing mode to perform editing.

When the convenient editing mode is selected, a corresponding interaction interface pops up, and a user may directly drag a target skeleton point of a model virtual character, and drive a plurality of skeletons bound upwards to the target skeleton point, to displace together. In addition, a UI adjustment wheel may be used to perform movement in three directions, that is, X/Y/Z directions. Three-axis model direction lines are displayed on the target skeleton point, so that the user can understand a moving direction.

When the expert editing mode is selected, a corresponding interaction interface pops up, and the user may use a UI adjustment wheel to move, in three directions, that is, X/Y/Z directions, the skeleton corresponding to the target skeleton point. A direction line of the three-dimensional spherical model is displayed on the target skeleton point, to facilitate understanding of an arc position of rotation.

After the skeleton editing mode is entered, the orientation mode may be entered by default or selected, to edit the face orientation of the character. The user may use a default initial face orientation. Alternatively, a camera viewing control may be triggered, so that the head of the character moves to a current position of the camera. Alternatively, a 3D positioning ball may be generated in the scene, so that the character watches a position of the ball. The player may change the position of the ball in the scene, and the character always orients towards the ball.

After the skeleton editing mode is entered, a sight line mode may be entered by default or selected, to edit a sight line orientation of the character. The user may use a default initial sight line orientation. Alternatively, a camera viewing control may be triggered, so that the sight line of the character watches a current position of the camera. Alternatively, a 3D positioning ball may be generated in the scene, so that the character watches a position of the ball. The player may change the position of the ball in the scene, and the sight line of the character always watches the ball.

After the skeleton editing mode is entered, a gesture mode may be entered by default or selected, to edit a hand posture of the character. The user may choose to only replace a hand posture of the left hand, or only replace a hand posture of the right hand, or replace hand postures of both left and right hands. The user may select a piece of overall gesture skeleton data that needs to be replaced, for example, forming a heart shape or thumb up.

After the skeleton editing mode is entered, an expression mode may be entered by default or selected, to edit a face posture of the character. The user may select a piece of overall face skeleton data that needs to be replaced, for example, being sad or blinking an eye.

The user may further select a circular region, and export a posture of a model virtual character in the circular region. The user may also be in a multi-person editor mode.

### 6. Detect a Limit.

When the user adjusts the skeleton, the posture system needs to detect at least one of the following limits:

(1) Limit value of skeleton physiological rotation angle: Rotation angle limits of three axes x/y/z of each skeleton are planned and configured, and are controlled to not exceed a physiological limit of a model virtual character.

(2) Rotation angle limit of skeleton editing degree of freedom: Rotation angle limits of three axes x/y/z of each skeleton are restricted, so that a variation is controlled to not deviate excessively from an initial posture.

### 7. Store Data.

The user may store the customized posture. When determining to store the data, the posture system records an absolute value of a rotation angle of each skeleton point. In addition, the client photographs the character at a fixed angle, to form a cover image in a new posture. Then, data is created and uploaded to a server, and a unique ID is generated for storage. The client stores the solution to a user work set UI.

### 8. Store and Apply.

The user may re-modify or name the stored posture work to facilitate management. In addition, application may also be clicked on in a posture/work interface, data stored in the server is obtained by using the unique ID, and the posture data is applied to a virtual character controlled by the user, so that the virtual character controlled by the user is in the customized posture.

### 9. Share and Record.

The user may forward to share the solution with another person, and the another person sees a preview cover image and author-related information of the posture work. The user may further click on a posture work shared by another person, to perform recording, and store, in a posture work set of the user, the posture work shared by another person. Alternatively, the user directly clicks on the posture work for application, to apply a posture work shared by another person to a virtual character controlled by the user.

Two or more of the foregoing method aspects may be combined according to understanding of a person skilled in the art, to form more aspects. Details are not described described herein.

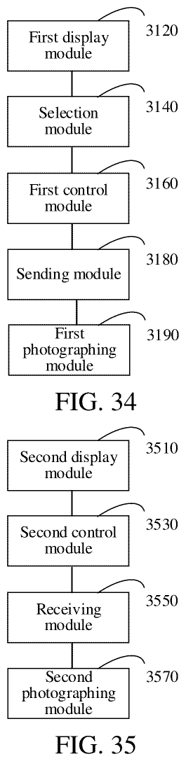

FIG. 34 is a schematic structural diagram of a virtual character posture editing apparatus according to an illustrative aspect described herein. The apparatus includes:
a first display module 3120, configured to obtain at least one candidate group posture, each candidate group posture of the at least one candidate group posture corresponding to postures of at least two virtual characters; and
a selection module 3140, configured to display, in a virtual environment in response to a selection operation on a first group posture of the at least one candidate group posture, at least two circular regions corresponding to the first group posture, the circular regions being in a one-to-one correspondence with postures in the first group posture;
the first display module 3120 being further configured to display, after different virtual characters enter different circular regions of the at least two circular regions, postures corresponding to the circular regions in which the different virtual characters are located.

In some aspects, the first display module 3120 is further configured to display, in the virtual environment in response to the selection operation on the first group posture of the at least one candidate group posture by using a position of a first virtual character as a central reference point of the first group posture and using an orientation of the first virtual character as a reference orientation of the first group posture, the at least two circular regions corresponding to the first group posture; where
the first virtual character is a virtual character whose control permission is possessed by the first account.

In some aspects, the first display module 3120 is further configured to refresh, in response to a change of the position of the first virtual character by using a position to which the first virtual character changes as a central reference point of the first group posture, display of the at least two circular regions corresponding to the first group posture; or
refresh, in response to a change of the orientation of the first virtual character by using an orientation to which the first virtual character changes as a reference orientation of the first group posture, display of the at least two circular regions corresponding to the first group posture; or
refresh, in response to a change of the position and the orientation of the first virtual character by using a position to which the first virtual character changes as a central reference point of the first group posture and using an orientation to which the first virtual character changes as a reference orientation of the first group posture, display of the at least two circular regions corresponding to the first group posture.

In some aspects, the first display module 3120 is further configured to display, in the virtual environment in response to a selection operation on a second group posture of the at least one candidate group posture by using the position of the first virtual character as a central reference point of the second group posture and using the orientation of the first virtual character as a reference orientation of the second group posture, at least two circular regions corresponding to the second group posture; where
the at least two circular regions of the first group posture and the at least two circular regions of the second group posture are displayed by using different display parameters.

In some aspects, the first display module 3120 is further configured to display a circular region sequence number in each of the at least two circular regions.

In some aspects, the apparatus further includes a first control module 3160, configured to control the first virtual character to enter a first circular region of the at least two circular regions, and control the first virtual character to apply, in the first circular region, a first posture corresponding to the first circular region.

In some aspects, the first display module 3120 is further configured to display that a second virtual character enters a second circular region of the at least two circular regions, and display that the second virtual character applies, in the second circular region, a second posture corresponding to the second circular region.

In some aspects, the apparatus further includes a sending module 3180, configured to send, to the second account, an application invitation for joining the first group posture; or
send, to a specified group, an application invitation for joining the first group posture, where the specified group includes the second account.

In some aspects, the apparatus further includes a first photographing module 3190, configured to: in response to a trigger operation on a photographing function, photograph a group posture formed by postures corresponding to the different virtual characters.

In some aspects, the first display module 3120 is further configured to cancel display of the at least two circular regions in response to a trigger operation on a photographing function.

In conclusion, in the apparatus provided in the aspects described herein, after different virtual characters enter circular regions corresponding to a candidate group posture, postures corresponding to the circular regions can be quickly displayed, thereby reducing a large number of operations in an editing process of a group posture and reducing a large number of operations in a display process of a group posture. For an electronic device with limited operation manners, such as a mobile phone or a tablet computer, human computer operation costs of a user can be reduced, and a group posture corresponding to a plurality of virtual characters can be displayed more easily and more quickly with fewer human computer operations, so that a group image of the plurality of virtual characters is displayed according to a candidate group posture. A quick, accurate, and convenient UGC generation, application, and sharing solution for a group posture is implemented.

FIG. 35 is a schematic structural diagram of a virtual character posture editing apparatus according to an illustrative aspect described herein. The apparatus includes:
a second display module 3510, configured to display, in a virtual environment, at least two circular regions corresponding to a first group posture, the first group posture corresponding to postures of at least two virtual characters, the first group posture being placed by a first account in the virtual environment, and the circular regions being in a one-to-one correspondence with the postures in the first group posture; and
a second control module 3530, configured to control a second virtual character to enter a second circular region of the at least two circular regions, and control the second virtual character to apply, in the second circular region, a second posture corresponding to the second circular region;
the second display module 3510 being further configured to display the second virtual character of the second posture located in the second circular region; and
the second display module 3510 being further configured to display, after another virtual character enters another circular region of the at least two circular regions, a posture corresponding to the circular region in which the another virtual character is located.

In some aspects, the second display module 3510 is further configured to display, in a case that the second virtual character moves to a peripheral range of the second circular region, a posture application control corresponding to the second circular region; and
the second control module 3530 is configured to control, in response to a trigger operation on the posture application control, the second virtual character to apply, in the second circular region, the second posture corresponding to the second circular region.

In some aspects, the second control module 3530 is configured to obtain, in response to the trigger operation on the posture application control, posture data and body orientation data of the second posture corresponding to the second circular region; and
apply the posture data and the body orientation data of the second posture to the second virtual character, so that the second virtual character applies, in the second circular region, the second posture corresponding to the second circular region.

In some aspects, the apparatus further includes a receiving module 3550, configured to receive an application invitation that is transmitted by the first account to the second account and that is for joining the first group posture; or receive an application invitation that is transmitted by the first account to a specified group and that is for joining the first group posture, where the specified group includes the second account.

In some aspects, the second display module 3510 is further configured to display, in the virtual environment in response to an acceptance operation on the application invitation, the at least two circular regions corresponding to the first group posture.

In some aspects, the second display module 3510 is further configured to display, in the virtual environment in a case that the second account and the first account belong to the same group, the at least two circular regions corresponding to the first group posture.

In some aspects, the apparatus further includes a second photographing module 3570, configured to: in response to a trigger operation on a photographing function, photograph a group posture formed by postures corresponding to the different virtual characters.

In some aspects, the second display module 3510 is further configured to cancel display of the at least two circular regions in response to a trigger operation on a photographing function.

In conclusion, in the apparatus provided in the aspects described herein, after different virtual characters enter circular regions corresponding to a candidate group posture, postures corresponding to the circular regions can be quickly displayed, thereby reducing a large number of operations in an editing process of a group posture and reducing a large number of operations in a display process of a group posture. For an electronic device with limited operation manners, such as a mobile phone or a tablet computer, human computer operation costs of a user can be reduced, and a group posture corresponding to a plurality of virtual characters can be displayed more easily and more quickly with fewer human computer operations.

When the apparatus provided in the foregoing aspects edits a virtual character posture, only division of the foregoing function modules is described by using examples. During practical application, the foregoing functions are completed by different function modules as required. In other words, an internal structure of the device is divided into different function modules to complete all or some of the functions described above. In addition, for details of a specific implementation process, reference is made to the method aspects, and details are not described herein again.

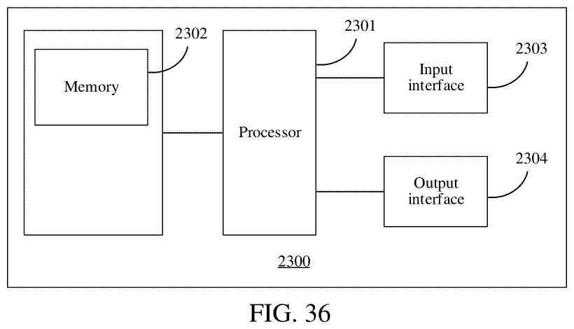

FIG. 36 is a structural block diagram of a computer device 2300 according to an illustrative aspect described herein.

Generally, the computer device 2300 includes: a processor 2301 and a memory 2302.

The processor 2301 may include one or more processing cores, for example, a 4-core processor or an 8-core processor. The processor 2301 may be implemented by using at least one hardware form of digital signal processor (DSP), a field-programmable gate array (FPGA), and a programmable logic array (PLA). The processor 2301 may alternatively include a main processor and a coprocessor. The main processor is configured to process data in an active state, and is also referred to as a central processing unit (CPU). The coprocessor is a processor with low power consumption configured to process data in a standby state. In some aspects, the processor 2301 may be integrated with a graphics processing unit (GPU). The GPU is configured to render and draw contents that need to be displayed on a display screen. In some aspects, the processor 2301 may further include an artificial intelligence (AI) processor, configured to process a machine learning related computing operation.

The memory 2302 may include one or more computer-readable storage mediums. The computer-readable storage medium may be non-transient. The memory 2302 may further include a high-speed random access memory and a nonvolatile memory, for example, one or more disk storage devices or flash storage devices. In some aspects, the non-transitory computer-readable storage medium in the memory 2302 is configured to store at least one instruction. The at least one instruction is executed by the processor 2301 to perform the virtual character posture editing method provided in the method aspect described herein.

In some aspects, the computer device 2300 further includes: an input interface 2303 and an output interface 2304. The processor 2301, the memory 2302, the input interface 2303, and the output interface 2304 may be connected through a bus or a signal cable. Each peripheral device may be connected to the input interface 2303 and the output interface 2304 by a bus, a signal cable, or a circuit board. The input interface 2303 and the output interface 2304 may be configured to connect at least one peripheral device related to input/output (I/O) to the processor 2301 and the memory 2302. In some aspects, the processor 2301, the memory 2302, the input interface 2303, and the output interface 2304 are integrated on the same chip or the same circuit board. In other aspects, any one or two of the processor 2301, the memory 2302, the input interface 2303, and the output interface 2304 may be implemented on a single chip or circuit board, which is not limited in this aspect described herein. A person skilled in the art may understand that the foregoing structure does not constitute a limitation on the computer device 2300, and the computer device may include more components or fewer components than those shown in the figure, or some components may be combined, or a different component deployment may be used.

An illustrative aspect further provides a computer device, including: a processor and a memory, the memory having a computer program stored therein, the computer program being loaded and executed by the processor to implement the virtual character posture editing method described above.

An illustrative aspect further provides a chip, including at least one of a programmable logic circuit and a program instruction, a server or a terminal installed with the chip being configured to implement the virtual character posture editing method described above.

An illustrative aspect further provides a computer-readable storage medium, having at least one segment of program stored therein, when being executed by a processor, the at least one segment of program being configured to implement the virtual character posture editing method described above. In some aspects, the computer-readable storage medium may be a read-only memory (ROM), a random access memory (RAM), a compact disc read-only memory (CD-ROM), a magnetic tape, a floppy disk, an optical data storage device, and the like.

An illustrative aspect further provides a computer program product, including a computer program, the computer program being stored in a computer-readable storage medium, and a processor reading the computer program from the computer-readable storage medium and executing the computer program to implement the virtual character posture editing method described above.

What is claimed is:

1. A computer-implemented method, comprising:
obtaining at least one candidate group posture, each candidate group posture of the at least one candidate group posture corresponding to postures of at least two virtual characters;
displaying, in a virtual environment in response to a selection operation on a first group posture of the at least one candidate group posture, at least two circular regions corresponding to the first group posture, the circular regions being in a one-to-one correspondence with postures in the first group posture; and
displaying, after different virtual characters enter different circular regions of the at least two circular regions, postures for each of the different virtual characters corresponding to the circular regions in which the different virtual characters are located.

2. The method of claim 1, wherein the displaying at least two circular regions comprises:
displaying, in the virtual environment in response to the selection operation on the first group posture of the at least one candidate group posture by using a position of a first virtual character as a central reference point of the first group posture and using an orientation of the first virtual character as a reference orientation of the first group posture, the at least two circular regions corresponding to the first group posture; wherein
the first virtual character is a virtual character whose control permission is possessed by a first account associated with the selection operation.

3. The method of claim 2, further comprising:
refreshing, in response to a change of the position of the first virtual character by using a position to which the first virtual character changes as a central reference point of the first group posture, display of the at least two circular regions corresponding to the first group posture;
or
refreshing, in response to a change of the orientation of the first virtual character by using an orientation to which the first virtual character changes as a reference orientation of the first group posture, display of the at least two circular regions corresponding to the first group posture;
or
refreshing, in response to a change of the position and the orientation of the first virtual character by using a position to which the first virtual character changes as a central reference point of the first group posture and using an orientation to which the first virtual character changes as a reference orientation of the first group posture, display of the at least two circular regions corresponding to the first group posture.

4. The method of claim 2, further comprising:
displaying, in the virtual environment in response to a selection operation on a second group posture of the at least one candidate group posture by using the position of the first virtual character as a central reference point of the second group posture and using the orientation of the first virtual character as a reference orientation of the second group posture, at least two circular regions corresponding to the second group posture; wherein
the at least two circular regions of the first group posture and the at least two circular regions of the second group posture are displayed by using different display parameters.

5. The method of claim 1, further comprising: displaying a circular region sequence number in each of the at least two circular regions; wherein
the circular region sequence number is used to uniquely identify a current circular region in a management process of the at least two circular regions corresponding to the first group posture, and the management process comprises at least one of a data storing process, a circular region adding process, and a circular region decreasing process.

6. The method of claim 1, wherein the displaying postures for each of the different virtual characters comprises:
controlling the first virtual character to enter a first circular region of the at least two circular regions, and controlling the first virtual character to apply, in the first circular region, a first posture corresponding to the first circular region; and
displaying that a second virtual character enters a second circular region of the at least two circular regions, and displaying that the second virtual character applies, in the second circular region, a second posture corresponding to the second circular region; wherein
the first virtual character is a virtual character whose control permission is possessed by a first account, and the second virtual character is a virtual character whose control permission is possessed by a second account.

7. The method according to claim 6, further comprising:
transmitting, to the second account, an application invitation for joining the first group posture;
or
transmitting, to a specified group, an application invitation for joining the first group posture, wherein the specified group comprises the second account.

8. The method of claim 1, further comprising:
canceling, in response to a trigger operation on a photographing function, display of the at least two circular regions, and photographing a group posture formed by postures corresponding to the different virtual characters.

9. The method of claim 1, wherein the at least one candidate group posture comprises: at least one of a preset group posture or a generated group posture.

10. A computer-implemented method comprising:
displaying, in a virtual environment, at least two circular regions corresponding to a first group posture, the first group posture corresponding to postures of at least two virtual characters, the first group posture being placed by a first account in the virtual environment, and the circular regions being in a one-to-one correspondence with the postures in the first group posture;
controlling, by a client device in which a second account is logged in, a second virtual character to enter a second circular region of the at least two circular regions, and controlling the second virtual character to apply, in the second circular region, a second posture corresponding to the second circular region;
displaying the second virtual character of the second posture located in the second circular region; and
displaying, after another virtual character enters another circular region of the at least two circular regions, a posture corresponding to the circular region in which the another virtual character is located.

11. The method of claim 10, wherein the controlling comprises:
displaying, when the second virtual character moves to a peripheral range of the second circular region, a posture application control corresponding to the second circular region; and
controlling, in response to a trigger operation on the posture application control, the second virtual character to apply, in the second circular region, the second posture corresponding to the second circular region.

12. The method of claim 11, wherein the controlling, in response to the trigger operation on the posture application control, the second virtual character to apply, in the second circular region, the second posture corresponding to the second circular region comprises:
obtaining, in response to the trigger operation on the posture application control, posture data and body orientation data of the second posture corresponding to the second circular region; and
applying the posture data and the body orientation data to the second virtual character, so that the second virtual character applies, in the second circular region, the second posture corresponding to the second circular region.

13. The method of claim 10, further comprising:
receiving an application invitation that is transmitted by the first account to the second account and that is for joining the first group posture; or receiving an application invitation that is transmitted by the first account to a specified group and that is for joining the first group posture, wherein the specified group comprises the second account; and
the displaying, in a virtual environment, at least two circular regions corresponding to a first group posture comprises:
displaying, in the virtual environment in response to an acceptance operation on the application invitation, the at least two circular regions corresponding to the first group posture.

14. The method of claim 10, wherein the displaying at least two circular regions comprises:
displaying, in the virtual environment when the second account and the first account belong to the same group, the at least two circular regions corresponding to the first group posture.

15. The method of claim 10, further comprising:
canceling, in response to a trigger operation on a photographing function, display of the at least two circular regions, and photographing a group posture formed by postures corresponding to the different virtual characters.

16. One or more non-transitory computer readable media comprising computer readable instructions which, when executed by a processor, configure a data processing system to perform:
obtaining at least one candidate group posture, each candidate group posture of the at least one candidate group posture corresponding to postures of at least two virtual characters;
displaying, in a virtual environment in response to a selection operation on a first group posture of the at least one candidate group posture, at least two circular regions corresponding to the first group posture, the circular regions being in a one-to-one correspondence with postures in the first group posture; and
displaying, after different virtual characters enter different circular regions of the at least two circular regions, postures for each of the different virtual characters corresponding to the circular regions in which the different virtual characters are located.

17. The computer readable media of claim 16, wherein the displaying at least two circular regions comprises:
displaying, in the virtual environment in response to the selection operation on the first group posture of the at least one candidate group posture by using a position of a first virtual character as a central reference point of the first group posture and using an orientation of the first virtual character as a reference orientation of the first group posture, the at least two circular regions corresponding to the first group posture; wherein
the first virtual character is a virtual character whose control permission is possessed by a first account associated with the selection operation.

18. The computer readable media of claim 17, further comprising:
displaying, in the virtual environment in response to a selection operation on a second group posture of the at least one candidate group posture by using the position of the first virtual character as a central reference point of the second group posture and using the orientation of the first virtual character as a reference orientation of the second group posture, at least two circular regions corresponding to the second group posture; wherein
the at least two circular regions of the first group posture and the at least two circular regions of the second group posture are displayed by using different display parameters.

19. The computer readable media of claim 16, wherein the displaying postures for each of the different virtual characters comprises:
controlling the first virtual character to enter a first circular region of the at least two circular regions, and controlling the first virtual character to apply, in the first circular region, a first posture corresponding to the first circular region; and
displaying that a second virtual character enters a second circular region of the at least two circular regions, and displaying that the second virtual character applies, in the second circular region, a second posture corresponding to the second circular region; wherein
the first virtual character is a virtual character whose control permission is possessed by a first account, and the second virtual character is a virtual character whose control permission is possessed by a second account.

20. The computer readable media according to claim 19, wherein the instruction, when executed, further configure the data processing system to perform:
transmitting, to the second account, an application invitation for joining the first group posture;
or
transmitting, to a specified group, an application invitation for joining the first group posture, wherein the specified group comprises the second account.
